(19) United States
(12) Patent Application Publication
(10) Pub. No.: US 2025/0051698 A1
(43) Pub. Date: Feb. 13, 2025

(54) BEER-TASTE BEVERAGE

(71) Applicant: SUNTORY HOLDINGS LIMITED, Osaka-shi, Osaka (JP)

(72) Inventors: Yuichi Kato, Fuchu-shi (JP); Takaho Okajima, Fuchu-shi (JP); Taichi Maruhashi, Fuchu-shi (JP)

(73) Assignee: SUNTORY HOLDINGS LIMITED, Osaka-shi, Osaka (JP)

(21) Appl. No.: 18/719,427

(22) PCT Filed: Dec. 23, 2022
(86) PCT No.: PCT/JP2022/047525

§ 371 Date: Jun. 13, 2024

(30) Foreign Application Priority Data
Dec. 27, 2021 (JP) 2021-213199
Dec. 27, 2021 (JP) 2021-213202
Dec. 27, 2021 (JP) 2021-213292
Dec. 27, 2021 (JP) 2021-213293

(51) Int. Cl. C12C 12/00; C12C 11/00

(52) U.S. Cl. CPC C12C 12/00; C12C 11/00

(57) ABSTRACT

A beer-taste beverage having an original extract concentration of 20.0 mass % or more, an apparent fermentation degree of 70.0% or more and an alcohol content of less than 25.0 (v/v) %. A beer-taste beverage having a real extract concentration of 11.8 mass % or less and an alcohol content of 10.5 (v/v) % or more. A beer-taste beverage having an apparent fermentation degree of 70.0% or more and an alcohol content of 10.5 (v/v) % or more. A beer-taste beverage having an original extract concentration of 19.2 mass % or more and an alcohol content of 12.5 (v/v) % or more.

### TECHNICAL FIELD

The present invention relates to a beer-taste beverage.

### BACKGROUND ART

In the related art, various beer-taste beverages have been studied and provided in response to recent diversified preferences of consumers.

For example, Patent Document 1 describes a beer-taste beverage containing 0.3 to 5 ppm of quassin and/or 0.5 to 5 ppm of quinine for the purpose of providing a beer-taste beverage having beer-like bitterness and sharp aftertaste.

In such a situation, when an original extract concentration is increased to give a beer-like taste of barley, the taste tends to have a difficult-to-drink taste.

In such a situation, it is possible to give a stronger feeling of stimulation by increasing the alcohol content. However, when the alcohol content is increased, the beverage tends to become dry and have a difficult-to-drink taste.

Furthermore, in such a situation, there is a demand for a beer-taste beverage having an increased alcohol content in such a manner that a feeling of stimulation derived from alcohol is perceived. However, when the alcohol content is increased, the taste tends to become dry and have a difficult-to-drink taste.

In such a situation, there is a demand for a beer-taste beverage having an increased alcohol content in such a manner that a feeling of stimulation derived from alcohol is perceived. However, when the alcohol content is increased, the taste tends to become dry and have a difficult-to-drink taste.

### CITATION LIST

### Patent Document

Patent Document 1: JP 2017-6077 A

### SUMMARY OF INVENTION

### Technical Problem

There is a demand for a beer-taste beverage having a beer-like taste of barley and further having a clear and easy-to-drink taste.

There is also a demand for a beer-taste beverage having a feeling of stimulation and further having a refreshing taste.

Furthermore, there is a demand for a beer-taste beverage having a clearer and refreshing taste while having a feeling of stimulation derived from alcohol.

In addition, there is a demand for a beer-taste beverage further having a taste of barley while having a feeling of stimulation derived from alcohol.

### Solution to Problem

A first aspect of the present invention provides a beer-taste beverage having an original extract concentration greater than or equal to 20.0 mass %, an apparent attenuation greater than or equal to 70.0%, and an alcohol content less than 25.0 (v/v) %. That is, the first aspect of the present invention includes inventions of the following aspects.

[1]

A beer-taste beverage having an original extract concentration greater than or equal to 20.0 mass %, an apparent attenuation greater than or equal to 70.0%, and an alcohol content less than 25.0 (v/v) %.

[2]

The beer-taste beverage according to [1], in which an alcohol content of the beer-taste beverage is greater than or equal to 10.5 (v/v) %.

[3]

The beer-taste beverage according to [1] or [2], in which a chromaticity of the beer-taste beverage is greater than or equal to 5 EBC.

[4]

The beer-taste beverage according to any one of [1] to [3], in which a malt usage proportion of the beer-taste beverage is greater than or equal to 40 mass %.

[5]

The beer-taste beverage according to any one of [1] to [3], in which a malt usage proportion of the beer-taste beverage is greater than or equal to 50 mass %.

[6]

The beer-taste beverage according to any one of [1] to [5], in which the beer-taste beverage is a fermented beer-taste beverage.

[7]

A method for producing a beer-taste beverage having an original extract concentration greater than or equal to 20.0 mass % and an alcohol content less than 25.0 (v/v) %, the method including performing fermentation in such a manner that an apparent attenuation of the beer-taste beverage is greater than or equal to 70.0%.

[8]
A method for improving a flavor of a beer-taste beverage, the method including adjusting an original extract concentration to be greater than or equal to 20.0 mass %, an alcohol content to less than 25.0 (v/v) %, and an apparent attenuation to be greater than or equal to 70.0%.

A second aspect of the present invention provides a beer-taste beverage having a real extract concentration less than or equal to 11.8 mass % and an alcohol content greater than or equal to 10.5 (v/v) %.

That is, the second aspect of the present invention includes inventions of the following aspects.

[1]

A beer-taste beverage having a real extract concentration less than or equal to 11.8 mass % and an alcohol content greater than or equal to 10.5 (v/v) %.

[2]

The beer-taste beverage according to [1], in which a chromaticity of the beer-taste beverage is greater than or equal to 5.0 EBC.

[3]

The beer-taste beverage according to [1] or [2], in which a malt usage proportion of the beer-taste beverage is greater than or equal to 40 mass %.

[4]

The beer-taste beverage according to [1] or [2], in which a malt usage proportion of the beer-taste beverage is greater than or equal to 50 mass %.

[5]

The beer-taste beverage according to any one of [1] to [4], in which the beer-taste beverage is a fermented beer-taste beverage.

[6]

The beer-taste beverage according to any one of [1] to [5], in which a content of free amino nitrogen (FAN) of the beer-taste beverage is greater than or equal to 3 mg/100 mL.

[7]

The beer-taste beverage according to any one of [1] to [6], in which a raw material of the beer-taste beverage contains neither ethanol nor ethanol-containing composition.

[8]

The beer-taste beverage according to any one of [1] to [7], in which the beer-taste beverage satisfies Expression (1):

$$X / Y \leq 0.8 , \qquad Expression ( 1 )$$

where X represents a content (in mg/100 mL) of free amino nitrogen (FAN) of the beer-taste beverage, and Y represents a real extract concentration (in mass %) of the beer-taste beverage.

[9]

A method for producing a beer-taste beverage having a real extract concentration less than or equal to 11.8 mass %, the method including performing fermentation in such a manner that an alcohol content of the beer-taste beverage is greater than or equal to 10.5 (v/v) %.

[10]

A method for improving a flavor of a beer-taste beverage, the method including adjusting a real extract concentration to be less than or equal to 11.8 mass % and an alcohol content to be greater than or equal to 10.5 (v/v) %.

A third aspect of the present invention provides a beer-taste beverage having an apparent attenuation greater than or equal to 70.0% and an alcohol content greater than or equal to 10.5 (v/v) %. That is, the third aspect of the present invention includes inventions of the following aspects.

[1]

A beer-taste beverage having an apparent attenuation greater than or equal to 70.0% and an alcohol content greater than or equal to 10.5 (v/v) %.

[2]

The beer-taste beverage according to [1], in which a total nitrogen amount of the beer-taste beverage is greater than or equal to 68 mg/100 mL.

[3]

The beer-taste beverage according to [1] or [2], in which a malt proportion of the beer-taste beverage is greater than or equal to 40 mass %.

[4]

The beer-taste beverage according to [1] or [2], in which a malt proportion of the beer-taste beverage is greater than or equal to 50 mass %.

[5]

The beer-taste beverage according to any one of [1] to [4], in which the beer-taste beverage is a fermented beer-taste beverage.

[6]

The beer-taste beverage according to any one of [1] to [5], in which a raw material of the beer-taste beverage contains neither ethanol nor ethanol-containing composition.

[7]

The beer-taste beverage according to any one of [1] to [6], in which the beer-taste beverage is beer.

[8]

The beer-taste beverage according to any one of [1] to [7], in which the beer-taste beverage satisfies Expression (1):

$$X \times Y \geq 700 , \qquad Expression ( 1 )$$

where X represents an apparent attenuation (in %) of the beer-taste beverage, and Y represents an alcohol content (in (v/v) %) of the beer-taste beverage.

[9]

A method for producing a beer-taste beverage, the method including performing fermentation in such a manner that an apparent attenuation is greater than or equal to 70.0% and an alcohol content is greater than or equal to 10.5 (v/v) %.

[10]

The production method according to [9], in which the method includes neither ethanol addition nor ethanol-containing composition addition.

[11]

A method for improving a flavor of a beer-taste beverage, the method including adjusting an apparent attenuation to be greater than or equal to 70.0% and an alcohol content to be greater than or equal to 10.5 (v/v) %.

A fourth aspect of the present invention provides a beer-taste beverage having an original extract concentration greater than or equal to 19.2 mass % and an alcohol content greater than or equal to 12.5 (v/v) %. That is, the fourth aspect of the present invention includes inventions of the following aspects.

[1]

A beer-taste beverage having an original extract concentration greater than or equal to 19.2 mass % and an alcohol content greater than or equal to 12.5 (v/v) %.

[2]

The beer-taste beverage according to [1], in which a total polyphenol amount of the beer-taste beverage is greater than or equal to 42 mg/L.

[3]

The beer-taste beverage according to [1] or [2], in which a malt proportion of the beer-taste beverage is greater than or equal to 40 mass %.

[4]

The beer-taste beverage according to [1] or [2], in which a malt proportion of the beer-taste beverage is greater than or equal to 50 mass %.

[5]

The beer-taste beverage according to any one of [1] to [4], in which the beer-taste beverage is a fermented beer-taste beverage.

[6]

The beer-taste beverage according to any one of [1] to [5], in which a raw material of the beer-taste beverage contains neither ethanol nor ethanol-containing composition.

[7]

The beer-taste beverage according to any one of [1] to [6], in which the beer-taste beverage is beer.

[8]

The beer-taste beverage according to any one of [1] to [7], in which the beer-taste beverage satisfies Expression (1):

$$X \times Y \geq 240 , \qquad Expression ( 1 )$$

where X represents an original extract concentration (in mass %) of the beer-taste beverage, and Y represents an alcohol content (in (v/v) %) of the beer-taste beverage.

[9]

A method for producing a beer-taste beverage having an original extract concentration greater than or equal to 19.2 mass %, the method including performing fermentation in such a manner that an alcohol content is greater than or equal to 12.5 (v/v) %.

[10]

The production method according to [9], in which the method includes neither ethanol addition nor ethanol-containing composition addition.

[11]

A method for improving a flavor of a beer-taste beverage, the method including adjusting an original extract concentration to be greater than or equal to 19.2 mass % and an alcohol content to be greater than or equal to 12.5 (v/v) %.

### Advantageous Effects of Invention

According to the suitable first aspect of the present invention, there is provided a beer-taste beverage having a beer-like taste of barley and further having a clear and easy-to-drink taste.

According to the suitable second aspect of the present invention, there is provided a beer-taste beverage having a feeling of stimulation and further having a refreshing taste.

According to the suitable third aspect of the present invention, there is provided a beer-taste beverage having a clearer and refreshing taste while having a feeling of stimulation derived from alcohol.

According to the suitable fourth aspect of the present invention, there is provided a beer-taste beverage further having a taste of barley while having a feeling of stimulation derived from alcohol.

### DESCRIPTION OF EMBODIMENTS

### 1. Beer-Taste Beverage

In the present specification, the “beer-taste beverage” refers to an alcohol-containing carbonated beverage with a beer-like flavor. That is, unless otherwise specified, the beer-taste beverage in the present specification includes any carbonated beverage having a beer flavor.

Thus, the “beer-taste beverage” includes not only beers and fermented beer-taste beverages, which are malt-fermented beverages produced by fermenting malt, hops, and water as raw materials with yeast, but also carbonated beverages to which a beer flavoring containing an ester, a higher alcohol, lactone, or the like is added. Examples of the beer flavoring include isoamyl acetate, ethyl acetate, n-propanol, isobutanol, acetaldehyde, ethyl caproate, ethyl caprylate, isoamyl propionate, linalool, geraniol, citral, 4-vinylguaiacol (4-VG), 4-methyl-3-pentenoic acid, 2-methyl-2-pentenoic acid, 1,4-cineol, 1,8-cineol, 2,3-diethyl-5-methylpyrazine, γ-decanolactone, γ-undecalactone, ethyl hexanoate, ethyl 2-methylbutyrate, ethyl n-butyrate, myrcene, citral, limonene, maltol, ethyl maltol, phenylacetic acid, furaneol, furfural, methional, 3-methyl-2-butene-1-thiol, 3-methyl-2-butanethiol, diacetyl, ferulic acid, geranic acid, geranylacetate, ethyl butyrate, octanoic acid, decanoic acid, 9-decenoic acid, nonanoic acid, tetradecanoic acid, propanoic acid, 2-methylpropanoic acid, γ-butyrolactone, 2-aminoacetophenone, ethyl 3-phenylpropionate, 2-ethyl-4-hydroxy-5-methyl-3 (2H)-furanone, dimethylsulfone, 3-methylcyclopentane-1,2-dione, 2-methylbutanal, 3-methylbutanal, 2-methyltetrahydrofuran-3-one, 2-acetylfuran, 2-methyltetrahydrofuran-3-one, hexanal, hexanol, cis-3-hexenal, 1-octen-3-ol, β-eudesmol, 4-mercapto-4-methylpentan-2-one, β-caryophyllene, β-myrcene, furfuryl alcohol, 2-ethylpyrazine, 2,3-dimethylpyrazine, 2-methylbutyl acetate, isoamyl alcohol, 5-hydroxymethylfurfural, phenylacetaldehyde, 1-phenyl-3-butene-1-one, trans-2-hexenal, nonanal, and phenethyl alcohol.

Furthermore, the beer-taste beverage according to the present invention may be an ale beer-taste beverage brewed through a fermentation step using a top-fermenting yeast (such as Saccharomyces), a lager beer-taste beverage or a pilsner beer-taste beverage brewed through a fermentation step using a bottom-fermenting yeast (such as Saccharomyces), or the like. Furthermore, the beer-taste beverage according to the present invention may be a beer-taste beverage produced by mixing a beer-taste beverage brewed through a fermentation step using a top-fermenting yeast (such as Saccharomyces) and a beer-taste beverage brewed through a fermentation step using a bottom-fermenting yeast (such as Saccharomyces).

The beer-taste beverage according to the present invention is suitable for an aspect of packaging. Examples of the container include a bottle, a PET bottle, a can, and a barrel. From the viewpoint of easy portability, the container is preferably a can, a bottle, or a PET bottle. In particular, among the above-mentioned can, bottle, and PET bottle, those which can be recapped are preferable.

Optional additive raw materials such as grain and a sweetener that can be used for producing the beer-taste beverage according to the present invention are described in detail in “1.1 Raw materials”.

### (1) Beer-Taste Beverage According to First Aspect

When the original extract (O-Ex) concentration (original wort concentration) in the beer-taste beverage is high, the beer-like taste of barley is likely to be felt and wateriness is less likely to be felt. Thus, the original extract concentration of the beer-taste beverage according to the first aspect of the present invention is greater than or equal to 20.0 mass %, and may be greater than or equal to 21.0 mass %, greater than or equal to 21.5 mass %, greater than or equal to 22.0 mass %, greater than or equal to 22.5 mass %, greater than or equal to 23.0 mass %, greater than or equal to 23.5 mass %, greater than or equal to 24.0 mass %, greater than or equal to 24.5 mass %, greater than or equal to 25.0 mass %, greater than or equal to 25.5 mass %, greater than or equal to 26.0 mass %, greater than or equal to 26.5 mass %, greater than or equal to 27.0 mass %, greater than or equal to 27.5 mass %, greater than or equal to 28.0 mass %, greater than or equal to 28.5 mass %, greater than or equal to 29.0 mass %, greater than or equal to 29.5 mass %, greater than or equal to 30.0 mass %, greater than or equal to 30.5 mass %, greater than or equal to 31.0 mass %, greater than or equal to 31.5 mass %, or greater than or equal to 32.0 mass %. From the viewpoint of being easy to drink, the original extract concentration of the beer-taste beverage according to the first aspect of the present invention is preferably less than or equal to 50.0 mass %, more preferably less than or equal to 45.0 mass %, even more preferably less than or equal to 40.0 mass %, even more preferably less than or equal to 37.0 mass %, even more preferably less than or equal to 35.0 mass %, even more preferably less than or equal to 34.0 mass %, even more preferably less than or equal to 33.0 mass %, even more preferably less than or equal to 32.5 mass %, even more preferably less than or equal to 32.0 mass %, even more preferably less than or equal to 31.5 mass %, even more preferably less than or equal to 31.0 mass %, even more preferably less than or equal to 30.5 mass %, and particularly preferably less than or equal to 30.0 mass %, but may be 29.5 mass %, less than or equal to 29.0 mass %, 28.5 mass %, less than or equal to 28.0 mass %, less than or equal to 27.5 mass %, less than or equal to 27.0 mass %, less than or equal to 26.5 mass %, less than or equal to 26.0 mass %, less than or equal to 25.5 mass %, less than or equal to 25.0 mass %, less than or equal to 24. mass %, less than or equal to 24.0 mass %, less than or equal to 23.5 mass %, less than or equal to 23.0 mass %, less than or equal to 22.5 mass %, less than or equal to 22.0 mass %, less than or equal to 21.5 mass %, less than or equal to 21.0 mass %, less than or equal to 20.5 mass %, less than or equal to 20.0 mass %, less than or equal to 19.5 mass %, than or equal to 19.0 mass %.

The original extract concentration can be adjusted by appropriately setting the addition of diluting water or carbonated water, the types of raw materials (such as malt, corn grits, and sugar solution), the amounts of raw materials, the time for wort filtration, the pH of the wort filtration, the boiling time, the boiling temperature, and the like.

The original extract (original wort extract) of the beer-taste beverage according to the present invention can be measured, for example, by a method described in Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition of 2013).

As described above, when the original extract concentration is high, the beer-like taste of barley is likely to be felt and wateriness is less likely to be felt. However, when the original extract concentration is high, the beverage may be difficult to drink. Thus, in the beer-taste beverage according to the present invention, the apparent attenuation is increased to be greater than or equal to 70.0% by adjusting the saccharification condition and the fermentation condition, whereby it is possible to provide a beer-taste beverage which is easy to drink and has a clear taste.

The apparent attenuation of the beer-taste beverage according to the present invention is greater than or equal to 70.0%, but may be greater than or equal to 71.0%, greater than or equal to 72.0%, greater than or equal to 73.0%, greater than or equal to 74.0%, greater than or equal to 75.0%, greater than or equal to 76.0%, greater than or equal to 78.0%, greater than or equal to 80.0%, greater than or equal to 82.0%, greater than or equal to 84.0%, greater than or equal to 86.0%, greater than or equal to 88.0%, greater than or equal to 89.0%, greater than or equal to 90.0%, greater than or equal to 91.0%, greater than or equal to 92.0%, greater than or equal to 93.0%, greater than or equal to 94.0%, greater than or equal to 95.0%, greater than or equal to 96.0%, greater than or equal to 97.0%, greater than or equal to 98.0%, greater than or equal to 99.0%, greater than or equal to 100.0%, greater than or equal to 101.0%, greater than or equal to 102.0%, greater than or equal to 103.0%, greater than or equal to 104.0%, greater than or equal to 105.0%, greater than or equal to 106.0%, greater than or equal to 107.0%, greater than or equal to 108.0%, greater than or equal to 109.0%, 110.0%, or greater than or equal to 111.0%, from the viewpoint of providing a beer-taste beverage having a further improved rich taste derived from barley.

The apparent attenuation of the beer-taste beverage according to the present invention may be less than or equal to 110.0%, less than or equal to 105.0%, less than or equal to 104.0%, less than or equal to 103.0%, less than or equal to 102.0%, less than or equal to 101.0%, less than or equal to 100.0%, less than or equal to 99.0%, less than or equal to 98.0%, less than or equal to 97.0%, less than or equal to 96.0%, less than or equal to 95.0%, less than or equal to 94.0%, less than or equal to 93.0%, less than or equal to 92.0%, less than or equal to 91.0%, or less than or equal to 90.0%, from the viewpoint of providing a beer-taste beverage having a further improved beer-like taste of barley.

In the present specification, the “apparent attenuation” means the proportion of the concentration of sugar that can be consumed by yeast as a nutrient source for alcoholic fermentation to the total concentration of sugar contained in the pre-fermentation liquid. For example, the apparent attenuation AA of the beer-taste beverage according to the present invention can be calculated from Equation (1):

$$AA ( \% ) = 100 \times ( P - Es ) / P \qquad Equation ( 1 )$$

where “P” is an original extract (original wort extract) and can be measured by the method described in “BCOJ Beer Analysis Method” (fermentation of The Brewing Society of Japan, edited by Brewers Association of Japan, revised edition of Nov. 1, 2004).

In addition, “Es” represents an apparent extract of the beer-taste beverage. The apparent extract can be calculated, for example, from Equation (2) as described in “BCOJ Beer Analysis Method” (fermentation of The Brewing Society of Japan, edited by Brewers Association of Japan, revised edition of Nov. 1, 2004):

$$Es = - 460.234 + 662.649 \times D - 202.414 \times {D}^{2} \qquad Equation ( 1 )$$

where D is the specific gravity of a degassed beer-taste beverage.

The apparent extract “Es” may have a negative value depending on D in Equation (2), and thus the calculated apparent attenuation may exceed 100%.

Note that the apparent attenuation of the beer-taste beverage can be adjusted by appropriately setting the addition of diluting water or carbonated water, the types of raw materials (such as malt, corn grits, and sugar solution), the amounts of raw materials, the type of enzyme, the amount of enzyme added (also including a saccharolytic enzyme or an isomerase), the temperature in enzymatic reaction, the timing of enzyme addition, the saccharification time, the pH during saccharification, the temperature during saccharification, the pH in the preparation step (wort production step from feeding of malt until before addition of yeast), the temperature in the preparation step, the time for wort filtration, the set temperature and holding time in each temperature region in preparation of wort (including during saccharification), the original extract concentration in the pre-fermentation liquid, the original extract concentration in the fermentation step, the fermentation conditions (such as the oxygen concentration, aeration conditions, yeast species, amount of yeast added, the number of yeast grown, removal timing of yeast, fermentation temperature, fermentation time, pressure setting, and carbon dioxide concentration), the cooling timing, the cooling temperature, the cooling time, and the like.

The alcohol content of the beer-taste beverage is not particularly limited, and may be, for example, greater than or equal to 1.0 (v/v) %, greater than or equal to 2.0 (v/v) %, greater than or equal to 3.0 (v/v) %, greater than or equal to 3.5 (v/v) %, greater than or equal to 4.0 (v/v) %, greater than or equal to 4.5 (v/v) %, greater than or equal to 5.0 (v/v) %, greater than or equal to 5.5 (v/v) %, greater than or equal to 6.0 (v/v) %, greater than or equal to 6.5 (v/v) %, greater than or equal to 7.0 (v/v) %, greater than or equal to 8.0 (v/v) %, or greater than or equal to 9.0 (v/v) %. From the viewpoint of drinking sensation, the alcohol content is preferably greater than or equal to 10.0 (v/v) %, more preferably greater than or equal to 10.5 (v/v) %, and even more preferably greater than or equal to 11.0 (v/v) %, and may be further greater than or equal to 11.5 (v/v) %, greater than or equal to 12.0 (v/v) %, greater than or equal to 12.5 (v/v) %, greater than or equal to 13.0 (v/v) %, or greater than or equal to 13.5 (v/v) %. The alcohol content of the beer-taste beverage is less than 25.0 (v/v) %, preferably less than or equal to 24.0 (v/v) %, more preferably less than or equal to 23.0 (v/v) %, even more preferably less than or equal to 22.0 (v/v) %, still even more preferably less than or equal to 21.0 (v/v) %, and particularly preferably less than or equal to 20.0 (v/v) %, and may be less than or equal to 19.0 (v/v) %, less than or equal to 18.5 (v/v) %, less than or equal to 18.0 (v/v) %, less than or equal to 17.5 (v/v) %, less than or equal to 17.0 (v/v) %, less than or equal to 16.5 (v/v) %, less than or equal to 16.0 (v/v) %, less than or equal to 15.5 (v/v) %, less than or equal to 15.0 (v/v) %, less than or equal to 14.5 (v/v) %, less than or equal to 14.0 (v/v) %, less than or equal to 13.5 (v/v) %, less than or equal to 13.0 (v/v) %, less than or equal to 12.5 (v/v) %, less than or equal to 12.0 (v/v) %, less than or equal to 11.5 (v/v) %, or less than or equal to 11.0 (v/v) %.

Note that in the present specification, the alcohol content is represented by a percentage on a volume/volume basis ((v/v) %). The alcohol content of the beverage can be measured by any known method and can be measured, for example, with a vibrating densimeter.

The alcohol content can be adjusted by appropriately setting the addition of diluting water or carbonated water, the types of raw materials (such as malt, corn grits, and sugar solution), the amounts of raw materials, the type of enzyme, the amount of enzyme added, the timing of enzyme addition, the saccharification time in a preparation tank, the time for proteolysis in the preparation tank, the pH in the preparation tank, the pH in a preparation step (wort production step from feeding of malt until before addition of yeast), the amount of the acid to be added used in the pH adjustment, the timing of the pH adjustment (such as at the time of preparation, fermentation, or completion of fermentation, before beer filtration, and after beer filtration), the set temperature and holding time in each temperature region in preparation of wort (including during saccharification), the original extract concentration in a pre-fermentation liquid, the original extract concentration in the fermentation step, the fermentation conditions (such as the oxygen concentration, aeration conditions, yeast species, amount of yeast added, the number of yeast grown, the removal timing of yeast, fermentation temperature, fermentation time, pressure setting, and carbon dioxide concentration), the addition of a spirit, a distilled alcohol or the like, and the like.

The apparent attenuation of the beer-taste beverage according to the present invention is greater than or equal to 70.0%, and thus the beer-taste beverage according to the first aspect of the present invention can be produced by diluting, with carbonated water or the like, a beer-taste beverage stock solution generated under a fermentation condition in which the apparent attenuation becomes greater than or equal to 70.0%, or further adding an alcohol component with spirits or the like.

The beer-taste beverage according to the first aspect of the present invention may further contain spirits (liquor) derived from grain as an alcohol component.

In the present specification, the “spirits” means an alcoholic beverage produced by saccharifying grain, such as wheat, rice, buckwheat, corn, potato, or sugar cane, as a raw material using malt or, as necessary, an enzymatic agent, fermenting the saccharified product using yeast, and then distilling the fermented product. As the grain which is a raw material of the spirits, a plant belonging to the family Gramineae is preferable, and wheat is more preferable.

The chromaticity of the beer-taste beverage according to the first aspect of the present invention is preferably greater than or equal to 5.0 EBC, more preferably greater than or equal to 5.3 EBC, even more preferably greater than or equal to 5.6 EBC, still even more preferably greater than or equal to 5.9 EBC, and particularly preferably greater than or equal to 6.2 EBC, and may be greater than or equal to 6.5 EBC, greater than or equal to 7.0 EBC, greater than or equal to 7.5 EBC, or greater than or equal to 8.0 EBC, from the viewpoint of allowing a beer-like visual effect and beer-like aroma to be easily felt.

The chromaticity of the beer-taste beverage according to the first aspect of the present invention is preferably less than or equal to 80.0 EBC, more preferably less than or equal to 75.0 EBC, even more preferably less than or equal to 70.0 EBC, still even more preferably less than or equal to 65.0 EBC, still even more preferably less than or equal to 60.0 EBC, still even more preferably less than or equal to 55.0 EBC, still even more preferably less than or equal to 50.0 EBC, still even more preferably less than or equal to 45.0 EBC, still even more preferably less than or equal to 40.0 EBC, still even more preferably less than or equal to 35.0 EBC, still even more preferably less than or equal to 30.0 EBC, still even more preferably less than or equal to 25.0 EBC, still even more preferably less than or equal to 20.0 EBC, still even more preferably less than or equal to 15.0 EBC, still even more preferably less than or equal to 12.0 EBC, and still even more preferably less than or equal to 10.0 EBC.

In the present specification, the “chromaticity” of the beverage can be measured by the measurement method described in “8.8 Chromaticity” in Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition of 2013). Note that the “chromaticity” of the beverage is specified by the unit of chromaticity (EBC unit) defined by the European Brewery Convention. A beverage with a smaller numerical value has a lighter and brighter color, whereas a beverage with a larger numerical value has a deeper and darker color.

In addition, the chromaticity of the beer-taste beverage according to the first aspect of the present invention can be controlled, for example, by appropriately adjusting the type of malt used, the blending proportion in a case of using two or more types of malts in combination, or the boiling conditions for preparation of the pre-fermentation liquid. More specifically, for example, to increase the chromaticity of the beer-taste beverage, the chromaticity can be adjusted by increasing the blending proportion of dark malt as the malt, increasing the temperature during boiling treatment, increasing boiling time, performing decoction during preparation of a saccharified liquid, and the like. Furthermore, the chromaticity can also be adjusted to a higher level by increasing the original wort extract concentration or increasing the malt proportion. The chromaticity can also be adjusted by controlling the amount of a food additive such as caramel coloring, colored sugar solution, or the like.

The pH of the beer-taste beverage according to the first aspect of the present invention is not particularly limited, but is preferably greater than or equal to 3.0, more preferably greater than or equal to 3.1, more preferably greater than or equal to 3.2, even more preferably greater than or equal to 3.3, still even more preferably greater than or equal to 3.4, and particularly preferably greater than or equal to 3.5, and may be greater than or equal to 3.6, greater than or equal to 3.6, greater than or equal to 3.7, greater than or equal to 3.8, greater than or equal to 3.9, greater than or equal to 4.0, greater than or equal to 4.1, greater than or equal to 4.2, greater than or equal to 4.3, greater than or equal to 4.4, greater than or equal to 4.5, greater than or equal to 4.6, or greater than or equal to 4.7, from the viewpoint of improving a clear taste of the beverage. From the viewpoint of suppressing the generation of microorganisms, the pH of the beer-taste beverage is preferably less than or equal to 5.0, more preferably less than or equal to 4.9, even more preferably less than or equal to 4.8, still even more preferably less than or equal to 4.7, still even more preferably less than or equal to 4.6, and particularly preferably less than or equal to 4.5, and may be less than or equal to 4.4, less than or equal to 4.3, less than or equal to 4.2, less than or equal to 4.1, less than or equal to 4.0, less than or equal to 3.9, less than or equal to 3.8, less than or equal to 3.7, less than or equal to 3.6, less than or equal to 3.5, less than or equal to 3.4, or less than or equal to 3.3.

The pH can be adjusted by appropriately setting the addition of diluting water or carbonated water, the types of raw materials (such as malt, corn grits, and sugar solution), the amounts of raw materials, the type of enzyme, the amount of enzyme added, the timing of enzyme addition, the saccharification time in a preparation tank, the time for proteolysis in the preparation, the pH in the preparation tank, the pH in the preparation step (wort production step from feeding of malt until before addition of yeast), the type of the acid to be added used in the pH adjustment (such as lactic acid, phosphoric acid, malic acid, tartaric acid, or citric acid), the amount of the acid to be added used in the pH adjustment, the timing of pH adjustment (at the time of preparation, fermentation, completion of fermentation, before beer filtration, after beer filtration, or the like), the set temperature and holding time in each temperature region in preparation of wort (including the time of saccharification), the original extract concentration in the pre-fermentation liquid, the original extract concentration in the fermentation step, the fermentation conditions (such as the oxygen concentration, aeration conditions, yeast species, amount of yeast added, the number of yeast grown, removal timing of yeast, fermentation temperature, fermentation time, pressure setting, and carbon dioxide concentration), the cooling timing, the cooling temperature, the cooling time, and the like.

### (2) Beer-Taste Beverage According to Second Aspect

The alcohol content of the beer-taste beverage according to the second aspect of the present invention is greater than or equal to 10.5 (v/v) %, and may be greater than or equal to 10.6 (v/v) %, greater than or equal to 10.8 (v/v) %, greater than or equal to 11.0 (v/v) %, greater than or equal to 12.0 (v/v) %, greater than or equal to 13.0 (v/v) %, greater than or equal to 14.0 (v/v) %, greater than or equal to 15.0 (v/v) %, greater than or equal to 16.0 (v/v) %, greater than or equal to 17.0 (v/v) %, greater than or equal to 18.0 (v/v) %, or greater than or equal to 19.0 (v/v) % in such a manner that it is possible to impart a feeling of stimulation. The alcohol content of the beer-taste beverage is not particularly limited, but is preferably less than or equal to 25.0 (v/v) %, and more preferably less than or equal to 20.0 (v/v) % s, and may be less than or equal to 19.0 (v/v) %, less than or equal to 18.5 (v/v) %, less than or equal to 18.0 (v/v) %, less than or equal to 17.5 (v/v) %, less than or equal to 17.0 (v/v) %, less than or equal to 16.5 (v/v) %, less than or equal to 16.0 (v/v) %, less than or equal to 15.5 (v/v) %, less than or equal to 15.0 (v/v) %, less than or equal to 14.5 (v/v) %, less than or equal to 14.0 (v/v) %, less than or equal to 13.5 (v/v) %, less than or equal to 13.0 (v/v) %, less than or equal to 12.5 (v/v) %, less than or equal to 12.0 (v/v) %, less than or equal to 11.5 (v/v) %, or less than or equal to 11.0 (v/v) %.

The beer-taste beverage according to the second aspect of the present invention has an alcohol content greater than or equal to 10.5 (v/v) % to be able to impart a feeling of stimulation, and thus is likely to become dry and have a taste difficult to drink. Accordingly, to provide a clear and refreshing taste while having a feeling of stimulation, the real extract concentration of the beer-taste beverage according to the present invention is less than or equal to 11.8 mass %, preferably less than or equal to 11.6 mass %, more preferably less than or equal to 11.4 mass %, even more preferably less than or equal to 11.2 mass %, and particularly preferably less than or equal to 11.0 mass %, or may be less than or equal to 10.0 mass %, less than or equal to 9.5 mass %, less than or equal to 9.0 mass %, less than or equal to 8.5 mass %, less than or equal to 8.0 mass %, less than or equal to 7.5 mass %, less than or equal to 7.0 mass %, less than or equal to 6.5 mass %, less than or equal to 6.0 mass %, less than or equal to 5.5 mass %, less than or equal to 5.0 mass %, less than or equal to 4.5 mass %, less than or equal to 4.0 mass %, less than or equal to 3.5 mass %, or less than or equal to 3.0 mass %.

In the present specification, real extract is synonymous with authentic extract. The determination of the real extract is performed in accordance with “8.4.3 Alcolyzer method” in Revised BCOJ Beer Analysis Method, Enlarged and Revised Edition of 2013 (edited by [Analysis Committee] Brewery Convention of Japan, Brewers Association of Japan, published by Public Interest Incorporated Foundation, Brewing Society of Japan)”.

The real extract concentration can be adjusted by appropriately setting the addition of diluting water or carbonated water, the types of raw materials (such as malt, corn grits, and sugar solution), the pulverized grain size of malt, the pulverization mode of malt (such as wet pulverization and dry pulverization), the humidity at the time of pulverization of malt (extent of humidity adjustment), the temperature at the time of pulverization, the type of mill used at the time of pulverization, the amounts of raw materials, the type of enzyme, the amount of enzyme added, the timing of enzyme addition, the enzyme decomposition time, the saccharification time in a preparation tank, the time for proteolysis in the preparation tank, the pH in the preparation tank, the pH in a preparation step (wort production step from feeding of malt until before addition of yeast), the amount of the acid to be added used in the pH adjustment, the timing of the pH adjustment (such as at the time of preparation, fermentation. or completion of fermentation, before beer filtration, and after beer filtration), the set temperature and holding time in each temperature region in preparation of wort (including during saccharification), the wort filtration time, the temperature during the wort filtration, the pH during the wort filtration, the wort collection amount in the wort filtration, the amount of sparging water during the wort filtration, the pH of sparging water during the wort filtration, the temperature of sparging water during the wort filtration, the fermentation conditions (such as the oxygen concentration, aeration conditions, yeast species, amount of yeast added, the number of yeast grown, the removal timing of yeast, fermentation temperature, fermentation time, pressure setting, and carbon dioxide concentration), the addition of a spirit, a distilled alcohol or the like, and the like.

From the viewpoint of providing a beer-taste beverage having a clear and refreshing taste while having a feeling of stimulation, in the beer-taste beverage according to the second aspect of the present invention, the proportion of the alcohol content (v/v) % to the real extract concentration (mass %) [alcohol content/real extract concentration] is preferably greater than or equal to 0.5, more preferably greater than or equal to 0.7, even more preferably greater than or equal to 0.8, still even more preferably greater than or equal to 0.9, and particularly preferably greater than or equal to 1.0, and may be further greater than 1.0, greater than or equal to 1.5, greater than or equal to 2.0, greater than or equal to 2.5, greater than or equal to 3.0, greater than or equal to 3.5, greater than or equal to 4.0, greater than or equal to 4.5, greater than or equal to 5.0, greater than or equal to 5.5, greater than or equal to 6.0, greater than or equal to 6.5, or greater than or equal to 7.0, and less than or equal to 20, less than or equal to 18, less than or equal to 16, less than or equal to 14, less than or equal to 12, or less than or equal to 10.

In the present specification, the content of free amino acid nitrogen (FAN) is an amount corresponding to the total amount of free α-amino acid. The content of FAN in the beer-taste beverage according to the present invention is preferably greater than or equal to 3 mg/100 mL, more preferably greater than or equal to 5 mg/100 mL, even more preferably greater than or equal to 8 mg/100 mL, still even more preferably greater than or equal to 12 mg/100 mL, and particularly preferably greater than or equal to 15 mg/100 mL, and may be greater than or equal to 20 mg/100 mL, greater than or equal to 25 mg/100 mL, greater than or equal to 30 mg/100 mL, or greater than or equal to 35 mg/100 mL, and less than or equal to 150 mg/100 mL, less than or equal to 120 mg/100 mL, less than or equal to 100 mg/100 mL, less than or equal to 90 mg/100 mL, less than or equal to 80 mg/100 mL, less than or equal to 70 mg/100 mL, or less than or equal to 60 mg/100 mL, from the viewpoint of providing expansion of taste like a beer-taste beverage having a certain level or higher.

The content of FAN can be adjusted by appropriately setting the addition of diluting water or carbonated water, the addition of liquor such as spirits, the addition of brewage such as brewed alcohol, the types of raw materials (such as malt, corn grits, and sugar solution), the amounts of raw materials, the type of enzyme, the amount of enzyme added (also including a proteolytic enzyme), the temperature during the enzymatic reaction, the timing of enzyme addition, the time for proteolysis in a preparation tank, the pH in the preparation tank, the temperature in the preparation tank, the pH in a preparation step (wort production step from feeding of malt until before addition of yeast), the temperature in the preparation step, the time for wort filtration, the set temperature and holding time in each temperature region in preparation of wort, the boiling time and pH in a boiling step, the original extract concentration in the pre-fermentation liquid, the original extract concentration in a fermentation step, the fermentation conditions (such as the oxygen concentration, aeration conditions, yeast species, amount of yeast added, the number of yeast grown, removal timing of yeast, fermentation temperature, fermentation time, pressure setting, and carbon dioxide concentration), and the like.

In the present specification, the content of FAN can be measured by a method described in “8.18 Free Amino Nitrogen—Ninhydrin Colorimetric Method” of “BCOJ Beer Analysis Method” edited by [Analysis Committee] Brewery Convention of Japan, Brewers Association of Japan, Enlarged and Revised Edition of 2013 (Public Interest Incorporated Foundation, The Brewing Society of Japan).

When the real extract of the beer-taste beverage is decreased, the beverage has a clear and refreshing taste. In addition, when the content of FAN in the beer-taste beverage is increased, the taste of barley is improved, and the expansion of taste like a beer-taste beverage is improved. Accordingly, when the real extract/FAN of the beer-taste beverage is decreased, the beverage has a clear taste while having a taste of barley. Thus, the real extract concentration (in mass %) relative to FAN (in mg/100 mL) (real extract concentration/FAN) of the beer-taste beverage according to the second aspect of the present invention is preferably less than or equal to 0.8, more preferably less than or equal to 0.75, even more preferably less than or equal to 0.7, still even more preferably less than or equal to 0.65, and particularly preferably less than or equal to 0.6, and may be less than or equal to 0.55, less than or equal to 0.5, less than or equal to 0.45, less than or equal to 0.4, less than or equal to 0.35, less than or equal to 0.3, less than or equal to 0.25, or less than or equal to 0.2.

The beer-taste beverage according to the second aspect of the present invention may further contain spirits (liquor) derived from grain as an alcohol component. The beverage may be a liquor-containing beer-taste beverage, a liquor-containing fermented beer-taste beverage, a barley spirit-containing beer-taste beverage, or a wheat spirit-containing beer-taste beverage.

The chromaticity and pH of the beer-taste beverage according to the second aspect of the present invention are the same as those of the beer-taste beverage according to the first aspect of the present invention.

### (3) Beer-Taste Beverage According to Third Aspect

The apparent attenuation of the beer-taste beverage according to the present invention is greater than or equal to 70.0%, but may be greater than or equal to 72.0%, greater than or equal to 74.0%, greater than or equal to 76.0%, greater than or equal to 78.0%, greater than or equal to 80.0%, greater than or equal to 82.0%, greater than or equal to 84.0%, greater than or equal to 86.0%, greater than or equal to 88.0%, greater than or equal to 89.0%, greater than or equal to 90.0%, greater than or equal to 91.0%, greater than or equal to 92.0%, greater than or equal to 93.0%, greater than or equal to 94.0%, greater than or equal to 95.0%, greater than or equal to 96.0%, greater than or equal to 97.0%, greater than or equal to 98.0%, greater than or equal to 99.0%, greater than or equal to 100.0%, greater than or equal to 101.0%, greater than or equal to 102.0%, greater than or equal to 103.0%, greater than or equal to 104.0%, greater than or equal to 105.0%, greater than or equal to 106.0%, greater than or equal to 107.0%, greater than or equal to 108.0%, greater than or equal to 109.0%, greater than or equal to 110.0%, or greater than or equal to 111.0%, from the viewpoint of providing a beer-taste beverage having a further improved clear and refreshing taste.

The apparent attenuation of the beer-taste beverage according to the present invention is preferably less than or equal to 120.0%, more preferably less than or equal to 118.0%, even more preferably less than or equal to 116.0%, still even more preferably less than or equal to 114.0%, still even more preferably less than or equal to 112.0%, and particularly preferably less than or equal to 110.0%, or may be less than or equal to 108.0%, less than or equal to 106.0%, less than or equal to 104.0%, less than or equal to 102.0%, less than or equal to 100.0%, less than or equal to 98.0%, less than or equal to 96.0%, less than or equal to 94.0%, less than or equal to 93.0%, less than or equal to 92.0%, less than or equal to 91.0%, less than or equal to 90.0%, less than or equal to 88.0%, less than or equal to 86.0%, less than or equal to 84.0%, less than or equal to 82.0%, less than or equal to 80.0%, less than or equal to 78.0%, or less than or equal to 76.0%, from the viewpoint of providing a beer-taste beverage having a further improved beer-like taste of barley.

Note that the apparent attenuation of the beer-taste beverage can be adjusted by appropriately setting the addition of diluting water or carbonated water, the types of raw materials (such as malt, corn grits, and sugar solution), the amounts of raw materials, the type of enzyme, the amount of enzyme added (also including a saccharolytic enzyme or an isomerase), the temperature in enzymatic reaction, the timing of enzyme addition, the saccharification time, the pH during saccharification, the temperature during saccharification, the pH in the preparation step (wort production step from feeding of malt until before addition of yeast), the temperature in the preparation step, the time for wort filtration, the set temperature and holding time in each temperature region in preparation of wort (including during saccharification), the original extract concentration in the pre-fermentation liquid, the original extract concentration in the fermentation step, the fermentation conditions (such as the oxygen concentration, aeration conditions, yeast species, amount of yeast added, the number of yeast grown, removal timing of yeast, fermentation temperature, fermentation time, pressure setting, and carbon dioxide concentration), the cooling timing, the cooling temperature, the cooling time, and the like.

The alcohol content of the beer-taste beverage according to the present invention is greater than or equal to 10.5 (v/v) %, but

from the viewpoint of providing a beer-taste beverage having a further improved feeling of stimulation derived from alcohol, the content may be greater than or equal to 11.0 (v/v) %, greater than or equal to 11.5 (v/v) %, greater than or equal to 12.0 (v/v) %, greater than or equal to 12.5 (v/v) %, greater than or equal to 13.0 (v/v) %, greater than or equal to 13.5 (v/v) %, greater than or equal to 14.0 (v/v) %, greater than or equal to 14.5 (v/v) %, greater than or equal to 15.0 (v/v) %, greater than or equal to 15.5 (v/v) %, greater than or equal to 16.0 (v/v) %, greater than or equal to 16.5 (v/v) %, greater than or equal to 17.0 (v/v) %, greater than or equal to 17.5 (v/v) %, greater than or equal to 18.0 (v/v) %, greater than or equal to 18.5 (v/v) %, greater than or equal to 19.0 (v/v) %, greater than or equal to 19.5 (v/v) %, greater than or equal to 20.0 (v/v) %, or greater than or equal to 20.5 (v/v) %. The alcohol content of the beer-taste beverage may be less than or equal to 30.0 (v/v) %, less than or equal to 27.0 (v/v) %, less than or equal to 25.0 (v/v) %, less than or equal to 22.0 (v/v) %, less than or equal to 20.0 (v/v) %, less than or equal to 19.0 (v/v) %, less than or equal to 18.5 (v/v) %, less than or equal to 18.0 (v/v) %, less than or equal to 17.5 (v/v) %, less than or equal to 17.0 (v/v) %, less than or equal to 16.5 (v/v) %, less than or equal to 16.0 (v/v) %, less than or equal to 15.5 (v/v) %, less than or equal to 15.0 (v/v) %, less than or equal to 14.5 (v/v) %, less than or equal to 14.0 (v/v) %, less than or equal to 13.5 (v/v) %, less than or equal to 13.0 (v/v) %, less than or equal to 12.5 (v/v) %, less than or equal to 12.0 (v/v) %, less than or equal to 11.5 (v/v) %, or less than or equal to 11.0 (v/v) %.

The beer-taste beverage according to the third aspect of the present invention may be a beverage containing ethanol or an ethanol-containing composition as a raw material, or may be a beverage containing neither ethanol nor ethanol-containing composition as a raw material. As the ethanol-containing composition, it is preferable to use spirits (liquor) such as alcohol as raw material, shochu, awamori, whisky, brandy, vodka, rum, tequila, or gin, brewer's alcohol, or the like.

The beer-taste beverage according to the third aspect of the present invention may be beer.

In the present specification, the “beer” means a beverage produced by using malt, hops, water, and the like as raw materials and fermenting them with yeast, and specifically means one defined in the Interpretation Notice on the Liquor Tax Law and the Administrative Ordinance Related to Alcoholic Beverages and the like enforced on Apr. 1, 2018.

That is, in a case where the beer-taste beverage according to the third aspect of the present invention is beer, the apparent attenuation and the alcohol content are adjusted by the fermentation step using yeast.

The beer-taste beverage of the present invention preferably satisfies Expression (1) from the viewpoint of providing a beer-taste beverage in which at least one of the feeling of stimulation derived from alcohol and the clear and refreshing taste is further improved.

$$X \times Y \geq 700 , \qquad Expression ( 1 )$$

where X represents an apparent attenuation (in %) of the beer-taste beverage, and Y represents an alcohol content (in (v/v) %) of the beer-taste beverage.

X× defined in Expression (1) is greater than or equal to 700, preferably greater than or equal to 750, more preferably greater than or equal to 800, more preferably greater than or equal to 850, even more preferably greater than or equal to 900, still even more preferably greater than or equal to 950, and particularly preferably greater than or equal to 1000, and may be greater than or equal to 1050, greater than or equal to 1100, greater than or equal to 1150, greater than or equal to 1200, greater than or equal to 1250, greater than or equal to 1300, greater than or equal to 1350, or greater than or equal to 1400, and less than or equal to 3000, less than or equal to 2800, less than or equal to 2500, less than or equal to 2300, less than or equal to 2200, less than or equal to 2100, less than or equal to 2000, less than or equal to 1900, less than or equal to 1800, or less than or equal to 1700.

The chromaticity and pH of the beer-taste beverage according to the third aspect of the present invention are the same as those of the beer-taste beverage according to the first aspect of the present invention.

### (4) Beer-Taste Beverage According to Fourth Aspect

When the original extract (O-Ex) concentration (original wort concentration) in the beer-taste beverage is high, the beer-like taste of barley is likely to be felt and wateriness is less likely to be felt. Thus, the original extract concentration of the beer-taste beverage according to the fourth aspect of the present invention is greater than or equal to 19.2 mass %, preferably greater than or equal to 19.4 mass %, more preferably greater than or equal to 19.6 mass %, even more preferably greater than or equal to 19.8 mass %, and still even more preferably greater than or equal to 20.0 mass %, and may be greater than or equal to 20.5 mass %, greater than or equal to 21.0 mass %, greater than or equal to 21.5 mass %, greater than or equal to 22.0 mass %, greater than or equal to 22.5 mass %, greater than or equal to 23.0 mass %, greater than or equal to 23.5 mass %, greater than or equal to 24.0 mass %, greater than or equal to 24.5 mass %, greater than or equal to 25.0 mass %, greater than or equal to 25.5 mass %, greater than or equal to 26.0 mass %, greater than or equal to 26.5 mass %, greater than or equal to 27.0 mass %, greater than or equal to 27.5 mass %, greater than or equal to 28.0 mass %, greater than or equal to 28.5 mass %, greater than or equal to 29.0 mass %, greater than or equal to 29.5 mass %, greater than or equal to 30.0 mass %, greater than or equal to 30.5 mass %, greater than or equal to 31.0 mass %, or greater than or equal to 31.5 mass %. From the viewpoint of being easy to drink, the original extract concentration of the beer-taste beverage according to the fourth aspect of the present invention is preferably less than or equal to 50.0 mass %, more preferably less than or equal to 45.0 mass %, even more preferably less than or equal to 40.0 mass %, still even more preferably less than or equal to 37.0 mass %, still even more preferably less than or equal to 35.0 mass %, still even more preferably less than or equal to 34.0 mass %, still even more preferably less than or equal to 33.0 mass %, still even more preferably less than or equal to 32.5 mass %, and still even more preferably less than or equal to 32.0 mass %, and may be less than or equal to 31.5 mass %, less than or equal to 31.0 mass %, less than or equal to 30.5 mass %, less than or equal to 30.0 mass %, less than or equal to 29.5 mass %, less than or equal to 29.0 mass %, less than or equal to 28.5 mass %, less than or equal to 28.0 mass %, less than or equal to 27.5 mass %, less than or equal to 27.0 mass %, less than or equal to 26.5 mass %, less than or equal to 26.0 mass %, less than or equal to 25.5 mass %, less than or equal to 25.0 mass %, less than or equal to 24. mass %, less than or equal to 24.0 mass %, less than or equal to 23.5 mass %, less than or equal to 23.0 mass %, less than or equal to 22.5 mass %, less than or equal to 22.0 mass %, less than or equal to 21.5 mass %, less than or equal to 21.0 mass %, or less than or equal to 20.5 mass %.

The original extract concentration of the beer-taste beverage according to the fourth aspect of the present invention is greater than or equal to 19.2 mass %, and it is necessary to increase the original extract concentration to be higher than that of a normal beverage. To increase the original extract concentration, it is preferable to securely take out an extract content from a raw material such as malt. When the beer-taste beverage according to the fourth aspect of the present invention is produced, to increase the original extract concentration, it is preferable to adjust the selection of raw materials, the pulverization particle size and pulverization mode of the grain raw material such as mash conk and malt during saccharification, the setting of wort filtration, the boiling time, the boiling temperature, and the like.

The original extract (original wort extract) of the beer-taste beverage according to the present invention can be measured, for example, by a method described in Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition of 2013).

When the alcohol content is high, the beverage tends to become dry and become difficult to drink, but by increasing the original extract concentration, a beer-like taste of barley is likely to be felt, which makes it possible to provide a beer-taste beverage having a feeling of stimulation derived from alcohol and a taste of barley.

The alcohol content of the beer-taste beverage according to the present invention is greater than or equal to 12.5 (v/v) %, but

from the viewpoint of providing a beer-taste beverage having a further improved feeling of stimulation derived from alcohol, the content may be greater than or equal to 13.0 (v/v) %, greater than or equal to 13.5 (v/v) %, greater than or equal to 14.0 (v/v) %, greater than or equal to 14.5 (v/v) %, greater than or equal to 15.0 (v/v) %, greater than or equal to 15.5 (v/v) %, greater than or equal to 16.0 (v/v) %, greater than or equal to 16.5 (v/v) %, greater than or equal to 17.0 (v/v) %, greater than or equal to 17.5 (v/v) %, greater than or equal to 18.0 (v/v) %, greater than or equal to 18.5 (v/v) %, greater than or equal to 19.0 (v/v) %, greater than or equal to 19.5 (v/v) %, greater than or equal to 20.0 (v/v) %, or greater than or equal to 20.5 (v/v) %. The alcohol content of the beer-taste beverage is preferably less than or equal to 25.0 (v/v) %, more preferably less than or equal to 24.0 (v/v) %, even more preferably less than or equal to 23.0 (v/v) %, still even more preferably less than or equal to 22.0 (v/v) %, more preferably less than or equal to 21.0 (v/v) %, still even more preferably less than or equal to 20.0 (v/v) %, and still even more preferably less than or equal to 19.5 (v/v) %, and may be less than or equal to 19.0 (v/v) %, less than or equal to 18.5 (v/v) %, less than or equal to 18.0 (v/v) %, less than or equal to 17.5 (v/v) %, less than or equal to 17.0 (v/v) %, less than or equal to 16.5 (v/v) %, less than or equal to 16.0 (v/v) %, less than or equal to 15.5 (v/v) %, less than or equal to 15.0 (v/v) %, less than or equal to 14.5 (v/v) %, less than or equal to 14.0 (v/v) %, less than or equal to 13.5 (v/v) %, or less than or equal to 13.0 (v/v) %.

The alcohol content can be adjusted by appropriately setting the addition of diluting water or carbonated water, the types of raw materials (such as malt, corn grits, and sugar solution), the amounts of raw materials, the type of enzyme, the amount of enzyme added, the timing of enzyme addition, the saccharification time in a preparation tank, the time for proteolysis in the preparation tank, the pH in the preparation tank, the pH in a preparation step (wort production step from feeding of malt until before addition of yeast), the amount of the acid to be added used in the pH adjustment, the timing of the pH adjustment (such as at the time of preparation, fermentation, or completion of fermentation, before beer filtration, and after beer filtration), the set temperature and holding time in each temperature region in preparation of wort (including during saccharification), the original extract concentration in a pre-fermentation liquid, the original extract concentration in the fermentation step, the fermentation conditions (such as the oxygen concentration, aeration conditions, yeast species, amount of yeast added, the number of yeast grown, the removal timing of yeast, fermentation temperature, fermentation time, pressure setting, and carbon dioxide concentration), the addition of a spirit, a distilled alcohol or the like, and the like.

The alcohol content of the beer-taste beverage according to the fourth aspect of the present invention is greater than or equal to 12.5 (v/v) %, which is higher than that of general beer. In general, yeast is easily damaged by alcohol produced by the yeast itself during fermentation, and when the yeast is damaged, the fermentation may be stopped in the middle and a predetermined alcohol content may not be obtained, the turbidity of the beer-taste beverage may be increased, the beer filterability may be deteriorated, an unpleasant flavor may be imparted to the beer-taste beverage, or an off-flavor may be generated. Accordingly, in a case where the alcohol content is increased in the fermentation step, it is preferable to optimize the state (activity) of yeast to be added and the temperature and pressure control during the fermentation.

The alcohol content of the beer-taste beverage according to the present invention is greater than or equal to 12.5 (v/v) %, and thus the beer-taste beverage according to the fourth aspect of the present invention may be produced by adding ethanol or an ethanol-containing composition to a beer-taste beverage stock solution generated by fermentation, or diluting the beer-taste beverage stock solution with carbonated water or the like.

The beer-taste beverage according to the fourth aspect of the present invention may be a beverage containing ethanol or an ethanol-containing composition as a raw material, or may be a beverage containing neither ethanol nor ethanol-containing composition as a raw material. As the ethanol-containing composition, it is preferable to use spirits (liquor) such as alcohol as raw material, shochu, awamori, whisky, brandy, vodka, rum, tequila, or gin, brewer's alcohol, or the like.

The beer-taste beverage according to the fourth aspect of the present invention may be beer.

When the beer-taste beverage according to the fourth aspect of the present invention is beer, the alcohol content is adjusted by the fermentation step using yeast.

The beer-taste beverage according to the present invention preferably satisfies Expression (1) from the viewpoint of providing a beer-taste beverage in which at least one of the feeling of stimulation derived from alcohol and the taste of barley is further improved.

$$X \times Y \geq 240 , \qquad Expression ( 1 )$$

where X represents an original extract concentration (original wort extract concentration) (in mass %) of the beer-taste beverage, and Y represents an alcohol content (in (v/v) %) of the beer-taste beverage.

X×Y defined in Expression (1) is greater than or equal to 240, preferably greater than or equal to 250, more preferably greater than or equal to 260, even more preferably greater than or equal to 270, still more preferably greater than or equal to 290, still even more preferably greater than or equal to 300, and particularly preferably greater than or equal to 320, and may be greater than or equal to 330, greater than or equal to 340, greater than or equal to 350, greater than or equal to 360, greater than or equal to 370, greater than or equal to 380, greater than or equal to 390, or greater than or equal to 400, and less than or equal to 625, less than or equal to 610, less than or equal to 600, less than or equal to 580, less than or equal to 560, less than or equal to 550, less than or equal to 530, less than or equal to 510, less than or equal to 500, or less than or equal to 490.

The chromaticity and pH of the beer-taste beverage according to the fourth aspect of the present invention are the same as those of the beer-taste beverage according to the first aspect of the present invention.

### 1.1 Raw Materials

The main raw materials of the beer-taste beverage according to the present invention are water and malt, but hops are preferably used. In addition, the fruit, skin, bark, leaf, flower, stem, roots, and seed of plants other than plants of the family Gramineae such as wheat, a sweetener, a water-soluble dietary fiber, a bittering agent or a bitterness imparting agent, an antioxidant, a flavoring, an acidulant, a salt, or the like may be used.

The malt refers to malt made by germinating seeds of barley or the like, such as barley, wheat, rye, common wild oat, oat, adlay, or oat, drying the germinated seeds, and removing roots, and may be from any production area and of any variety.

In the present invention, barley malt is preferably used. Barley malt is one of the malts most commonly used as a raw material for Japanese beer-taste beverages. There are several types of barley, such as two-rowed barley and six-rowed barley, and any of them may be used.

Furthermore, in addition to ordinary malt, colored malt or the like can also be used. When colored malt is used, different types of colored malts may be appropriately used in combination, or one colored malt may be used.

The beer-taste beverage according to the present invention may be a barley malt-containing beer-taste beverage, a barley malt-containing fermented beer-taste beverage, a barley malt-containing bottom-fermented beer-taste beverage, or a barley malt-containing top-fermented beer-taste beverage. These beer-taste beverages may contain liquor.

The modification of the malt used in the beer-taste beverage according to the present invention is preferably greater than or equal to 80%. When the modification is less than 80%, the viscosity of the wort increases or the turbidity thereof increases, and the production efficiency such as wort filterability or beer filterability deteriorates. Thus, it is preferable to use malt with modification of greater than or equal to 80%. In Examples and Comparative Examples, malt having a modification greater than or equal to 80% was used. The modification can be measured by the method described in 3.1.3.8 Modification and Homogeneity (Calcofluor Carlsberg Method—EBC) in MEBAK Raw Materials Barley Adjuncts Malt Hops And Hop Products Published by the Chairman Dr. Fritz Jacob Self-published by MEBAK 85350 Freising—Weihenstephan, Germany 2011.

Note that in the beer-taste beverage according to the present invention, the malt to be used is preferably selected as appropriate in accordance with the desired chromaticity of the beer-taste beverage, and the malt to be selected may be used alone or in combination of two or more kinds thereof.

Malt contains a nitrogen compound and a polyphenol. Thus, in the first aspect of the present invention, it is preferable to set the proportion of malt in the raw materials within a certain range for the purpose that the total nitrogen amount and the total polyphenol amount of the beer-taste beverage fall within the specified ranges. Specifically, the malt proportion (the proportion of all the malt used) is preferably greater than or equal to 50 mass %, more preferably greater than or equal to 51 mass %, even more preferably greater than or equal to 52 mass %, still even more preferably greater than or equal to 53 mass %, even more preferably greater than or equal to 54 mass %, still even more preferably greater than or equal to 55 mass %, even more preferably greater than or equal to 56 mass %, still even more preferably greater than or equal to 57 mass %, and particularly preferably greater than or equal to 58 mass %, and may be greater than or equal to 60 mass %, greater than or equal to 62 mass %, greater than or equal to 64 mass %, greater than or equal to 66 mass %, greater than or equal to 66.6 mass %, greater than or equal to 67 mass %, greater than or equal to 68 mass %, greater than or equal to 70 mass %, greater than or equal to 72 mass %, greater than or equal to 74 mass %, greater than or equal to 76 mass %, greater than or equal to 78 mass %, greater than or equal to 80 mass %, greater than or equal to 90 mass %, greater than or equal to 95 mass %, or 100 mass %. When the malt proportion is increased, it is possible to produce a beer-taste beverage which allows a rich taste derived from malt and a delicious taste of barley to be more strongly felt.

When the malt proportion is too high, an inappropriate feeling of fullness is likely to be given. Thus, the malt proportion is preferably less than 100 mass %, more preferably less than or equal to 95 mass %, even more preferably less than or equal to 90 mass %, more preferably less than or equal to 85 mass %, even more preferably less than or equal to 80 mass %, still even more preferably less than or equal to 78 mass %, still even more preferably less than or equal to 76 mass %, still even more preferably less than or equal to 74 mass %, still even more preferably less than or equal to 72 mass %, and still even more preferably less than or equal to 70 mass %, and may be less than or equal to 68 mass %, less than or equal to 67 mass %, less than or equal to 66.6 mass %, less than or equal to 66 mass %, less than or equal to 65 mass %, less than or equal to 63 mass %, less than or equal to 62 mass %, less than or equal to 60 mass %, or less than or equal to 58 mass %.

In the present specification, the “malt proportion” means a value calculated according to the Interpretation Notice on the Liquor Tax Law and the Administrative Ordinance Related to Alcoholic Beverages and the like enforced on Apr. 1, 2018.

Malt contains a nitrogen compound and a polyphenol. Thus, in the second aspect of the present invention, it is preferable to set the proportion of malt in the raw materials within a certain range for the purpose that the total nitrogen amount and the total polyphenol amount of the beer-taste beverage according to the present invention fall within the ranges specified in the present invention. Specifically, the malt proportion (the proportion of all the malts used) is preferably greater than or equal to 40 mass %, more preferably greater than or equal to 45 mass %, more preferably greater than or equal to 50 mass %, more preferably greater than or equal to 51 mass %, even more preferably greater than or equal to 52 mass %, still even more preferably greater than or equal to 53 mass %, even more preferably greater than or equal to 54 mass %, still even more preferably greater than or equal to 55 mass %, even more preferably greater than or equal to 56 mass %, still even more preferably greater than or equal to 57 mass %, and particularly preferably greater than or equal to 58 mass %. and may be greater than or equal to 60 mass %, greater than or equal to 62 mass %, greater than or equal to 64 mass %, greater than or equal to 66 mass %, greater than or equal to 66.6 mass %, greater than or equal to 67 mass %, greater than or equal to 68 mass %, greater than or equal to 70 mass %, greater than or equal to 72 mass %, greater than or equal to 74 mass %, greater than or equal to 76 mass %, greater than or equal to 78 mass %, greater than or equal to 80 mass %, greater than or equal to 90 mass %, greater than or equal to 95 mass %, or 100 mass %. When the malt proportion is increased, it is possible to produce a beer-taste beverage which allows a rich taste derived from malt and a delicious taste of barley to be more strongly felt.

When the malt proportion is too high, an inappropriate feeling of fullness is likely to be given. Thus, the malt proportion is preferably less than 100 mass %, more preferably less than or equal to 95 mass %, even more preferably less than or equal to 90 mass %, more preferably less than or equal to 85 mass %, even more preferably less than or equal to 80 mass %, still even more preferably less than or equal to 78 mass %, still even more preferably less than or equal to 76 mass %, still even more preferably less than or equal to 74 mass %, still even more preferably less than or equal to 72 mass %, and still even more preferably less than or equal to 70 mass %, and may be less than or equal to 68 mass %, less than or equal to 67 mass %, less than or equal to 66.6 mass %, less than or equal to 66 mass %, less than or equal to 65 mass %, less than or equal to 63 mass %, less than or equal to 62 mass %, less than or equal to 60 mass %, or less than or equal to 58 mass %.

Malt contains a nitrogen compound. Thus, in the third aspect of the present invention, it is preferable to set the proportion of malt in the raw materials within a certain range for the purpose that the total nitrogen amount of the beer-taste beverage according to the third aspect of the present invention fall within the ranges specified in the present invention. Specifically, the malt proportion (the proportion of all the malts used) is preferably greater than or equal to 40 mass %, more preferably greater than or equal to 45 mass %, more preferably greater than or equal to 50 mass %, more preferably greater than or equal to 51 mass %, even more preferably greater than or equal to 52 mass %, still even more preferably greater than or equal to 53 mass %, even more preferably greater than or equal to 54 mass %, still even more preferably greater than or equal to 55 mass %, even more preferably greater than or equal to 56 mass %, still even more preferably greater than or equal to 57 mass %, and particularly preferably greater than or equal to 58 mass %, and may be greater than or equal to 60 mass %, greater than or equal to 62 mass %, greater than or equal to 64 mass %, greater than or equal to 66 mass %, greater than or equal to 66.6 mass %, greater than or equal to 67 mass %, greater than or equal to 68 mass %, greater than or equal to 70 mass %, greater than or equal to 72 mass %, greater than or equal to 74 mass %, greater than or equal to 76 mass %, greater than or equal to 78 mass %, greater than or equal to 80 mass %, greater than or equal to 90 mass %, greater than or equal to 95 mass %, or 100 mass %. When the malt proportion is increased, it is possible to produce a beer-taste beverage which allows a rich taste derived from malt and a delicious taste of barley to be more strongly felt.

When the malt proportion is too high, an inappropriate feeling of fullness is likely to be given. Thus, the malt proportion is preferably less than 100 mass %, more preferably less than or equal to 95 mass %, more preferably less than or equal to 90 mass %, even more preferably less than or equal to 85 mass %, still even more preferably less than or equal to 80 mass %, still even more preferably less than or equal to 78 mass %, still even more preferably less than or equal to 76 mass %, still even more preferably less than or equal to 74 mass %, still even more preferably less than or equal to 72 mass %, and still even more preferably less than or equal to 70 mass %, and may be less than or equal to 68 mass %, less than or equal to 67 mass %, less than 67 mass %, less than or equal to 66.6 mass %, less than or equal to 66 mass %, less than or equal to 65 mass %, less than or equal to 63 mass %, less than or equal to 62 mass %, less than or equal to 60 mass %, or less than or equal to 58 mass %.

Malt contains a polyphenol. Thus, in the fourth aspect of the present invention, it is preferable to set the proportion of malt in the raw materials within a certain range for the purpose that the total polyphenol amount of the beer-taste beverage according to the fourth aspect of the present invention fall within a preferable range. Specifically, the malt proportion (the proportion of all the malts used) is preferably greater than or equal to 40 mass %, more preferably greater than or equal to 45 mass %, more preferably greater than or equal to 50 mass %, more preferably greater than or equal to 51 mass %, even more preferably greater than or equal to 52 mass %, still even more preferably greater than or equal to 53 mass %, even more preferably greater than or equal to 54 mass %, still even more preferably greater than or equal to 55 mass %, even more preferably greater than or equal to 56 mass %, still even more preferably greater than or equal to 57 mass %, and particularly preferably greater than or equal to 58 mass %, and may be greater than or equal to 60 mass %, greater than or equal to 62 mass %, greater than or equal to 64 mass %, greater than or equal to 66 mass %, greater than or equal to 66.6 mass %, greater than or equal to 67 mass %, greater than or equal to 68 mass %, greater than or equal to 70 mass %, greater than or equal to 72 mass %, greater than or equal to 74 mass %, greater than or equal to 76 mass %, greater than or equal to 78 mass %, greater than or equal to 80 mass %, greater than or equal to 90 mass %, greater than or equal to 95 mass %, or 100 mass %. When the malt proportion is increased, it is possible to produce a beer-taste beverage which allows a rich taste derived from malt and a delicious taste of barley to be more strongly felt.

When the malt proportion is too high, an inappropriate feeling of fullness is likely to be given. Thus, the malt proportion is preferably less than 100 mass %, more preferably less than or equal to 95 mass %, more preferably less than or equal to 90 mass %, even more preferably less than or equal to 85 mass %, still even more preferably less than or equal to 80 mass %, still even more preferably less than or equal to 78 mass %, still even more preferably less than or equal to 76 mass %, still even more preferably less than or equal to 74 mass %, still even more preferably less than or equal to 72 mass %, and still even more preferably less than or equal to 70 mass %, and may be less than or equal to 68 mass %, less than or equal to 67 mass %, less than 67 mass %, less than or equal to 66.6 mass %, less than or equal to 66 mass %, less than or equal to 65 mass %, less than or equal to 63 mass %, less than or equal to 62 mass %, less than or equal to 60 mass %, or less than or equal to 58 mass %.

In a case of suppressing the malt proportion, it is preferable to increase amounts of raw materials (carbon source and nitrogen source) other than malt, which can be utilized by yeast. Examples of the carbon source of the raw material that can be utilized by yeast include monosaccharides, disaccharides, trisaccharides, and sugar solutions thereof, and examples of the nitrogen source include yeast extract, soybean protein, malt, soybean, yeast extract, pea, wheat malt, ungerminated grains, and decomposition products thereof. Examples of the ungerminated grains include barley, wheat, rye, common wild oat, oat, adlay, oat, rice (such as white rice and brown rice), corn, kaoliang, potato, legumes (such as soybean and pea), buckwheat, sorghum, foxtail millet, and Japanese millet, which are ungerminated. In addition, starches derived from these grains and extracts thereof may be used.

The fruit, skin, bark, leaf, flower, stem, root, and seed of plants other than plants of the family Gramineae such as wheat are not particularly limited. Examples of the plant include citrus fruits, soft fruits, herbs, and spices. Examples of the citrus fruits include an orange, Citrus junos, a lemon, a lime, a mandarin orange, a grapefruit, Citrus Iyo Group, Citrus japonica, Citrus sphaerocarpa, Citrus limetta ‘Daidai’, Citrus depressa, and Citrus sudachi. Examples of the soft fruits include a peach, a grape, a banana, an apple, a grape, a pineapple, a strawberry, a pear, a muscat, and a blackcurrant. Examples of the herbs and the spices include coriander, pepper, fennel, Sichuan pepper, zanthoxyli fructus, cardamom, caraway, nutmeg, mace, juniper berry, allspice, vanilla, elderberry, grains of paradise, anise, and star anise.

These raw materials may be used as they are, may be used after being crushed, may be used in the form of an extract derived by extraction with a solvent such as water or ethanol, or may be used after being squeezed (fruit juice or the like). These raw materials may be used alone or in combination of two or more.

The above can be used as appropriate in accordance with the gusto of consumers, but in order to enjoy a clear and refreshing taste like beer, it is preferable that the above citrus fruits, soft fruits, herbs, and spices are not used at all or used in a minimum amount. In particular, a blackcurrant gives an inappropriate milky aroma in beer, and thus a blackcurrant or blackcurrant juice is preferably not used at all or used in a minimum amount.

The total nitrogen amount of the beer-taste beverage according to the third aspect of the present invention is preferably greater than or equal to 68 mg/100 mL, more preferably greater than or equal to 70 mg/100 mL, even more preferably greater than or equal to 73 mg/100 mL, still even more preferably greater than or equal to 75 mg/100 mL, even more preferably greater than or equal to 77 mg/100 mL, and particularly preferably greater than or equal to 79 mg/100 mL, from the viewpoint of providing a beer-taste beverage having a further improved delicious taste of barley, crispness, drinking sensation, robust taste, and savory taste, and may be greater than or equal to 80 mg/100 mL, greater than or equal to 82 mg/100 mL, greater than or equal to 84 mg/100 mL, greater than or equal to 86 mg/100 mL, greater than or equal to 88 mg/100 mL, greater than or equal to 90 mg/100 mL, greater than or equal to 92 mg/100 mL, greater than or equal to 94 mg/100 mL, greater than or equal to 96 mg/100 mL, greater than or equal to 98 mg/100 mL, greater than or equal to 100 mg/100 mL, greater than or equal to 102 mg/100 mL, greater than or equal to 104 mg/100 mL, greater than or equal to 106 mg/100 mL, greater than or equal to 108 mg/100 mL, greater than or equal to 110 mg/100 mL, greater than or equal to 112 mg/100 mL, greater than or equal to 114 mg/100 mL, greater than or equal to 116 mg/100 mL, greater than or equal to 118 mg/100 mL, greater than or equal to 120 mg/100 mL, greater than or equal to 122 mg/100 mL, greater than or equal to 124 mg/100 mL, greater than or equal to 126 mg/100 mL, greater than or equal to 128 mg/100 mL, greater than or equal to 130 mg/100 mL, greater than or equal to 132 mg/100 mL, greater than or equal to 134 mg/100 mL, greater than or equal to 136 mg/100 mL, greater than or equal to 138 mg/100 mL, greater than or equal to 140 mg/100 mL, greater than or equal to 142 mg/100 mL, greater than or equal to 144 mg/100 mL, greater than or equal to 146 mg/100 mL, greater than or equal to 148 mg/100 mL, greater than or equal to 150 mg/100 mL, greater than or equal to 152 mg/100 mL, greater than or equal to 154 mg/100 mL, greater than or equal to 156 mg/100 mL, greater than or equal to 158 mg/100 mL, or greater than or equal to 160 mg/100 mL.

On the other hand, when the total nitrogen amount is large, the taste of the beverage may become heavy. Thus, the total nitrogen amount of the beverage according to the third aspect of the present invention is preferably less than or equal to 180 mg/100 mL, more preferably less than or equal to 175 mg/100 mL, and even more preferably less than or equal to 170 mg/100 mL, and may be less than or equal to 168 mg/100 mL, less than or equal to 166 mg/100 mL, less than or equal to 164 mg/100 mL, less than or equal to 162 mg/100 mL, less than or equal to 160 mg/100 mL, less than or equal to 158 mg/100 mL, less than or equal to 154 mg/100 mL, less than or equal to 152 mg/100 mL, less than or equal to 150 mg/100 mL, less than or equal to 148 mg/100 mL, less than or equal to 146 mg/100 mL, less than or equal to 144 mg/100 mL, less than or equal to 142 mg/100 mL, less than or equal to 140 mg/100 mL, less than or equal to 138 mg/100 mL, less than or equal to 136 mg/100 mL, less than or equal to 134 mg/100 mL, less than or equal to 132 mg/100 mL, less than or equal to 130 mg/100 mL, less than or equal to 128 mg/100 mL, less than or equal to 126 mg/100 mL, less than or equal to 124 mg/100 mL, less than or equal to 122 mg/100 mL, less than or equal to 120 mg/100 mL, less than or equal to 118 mg/100 mL, less than or equal to 116 mg/100 mL, less than or equal to 114 mg/100 mL, less than or equal to 112 mg/100 mL, less than or equal to 110 mg/100 mL, less than or equal to 105 mg/100 mL, less than or equal to 100 mg/100 mL, less than or equal to 95 mg/100 mL, less than or equal to 90 mg/100 mL, less than or equal to 85 mg/100 mL, less than or equal to 80 mg/100 mL, less than or equal to 75 mg/100 mL, or less than or equal to 70 mg/100 mL.

The “total nitrogen amount” in the present specification is the total amount of all nitrogen compounds such as proteins and amino acids.

The total nitrogen amount of the beer-taste beverage according to the third aspect of the present invention can be controlled by adjusting the usage amount of a raw material that has a relatively high nitrogen content and can be utilized by yeast. Specifically, the total nitrogen amount can be increased by increasing the usage amount of a raw material with a high nitrogen content, such as malt. Examples of the raw material having a high nitrogen content include malt, a soybean, a yeast extract, a pea, and an ungerminated grain. Examples of the ungerminated grain include ungerminated barley, wheat, rye, common wild oat, oat, adlay, oat, a soybean, and a pea. The total nitrogen amount can be adjusted by, in addition to the amounts and the selection of types of the raw materials used, appropriately setting the type of enzyme, the amount of enzyme added (also including a proteolytic enzyme), the timing of enzyme addition, the time for proteolysis in a preparation tank, the pH in the preparation tank, the pH in the preparation step (wort production step from feeding of malt until before addition of yeast), the time for wort filtration, the set temperature and holding time in each temperature region in preparation of wort, the boiling time and pH in the boiling step, the original extract concentration in the pre-fermentation liquid, the original extract concentration in the fermentation step, the fermentation conditions (such as the oxygen concentration, aeration conditions, yeast species, amount of yeast added, the number of yeast grown, removal timing of yeast, fermentation temperature, fermentation time, pressure setting, and carbon dioxide concentration), and the like.

The total nitrogen amount of the beer-taste beverage according to the present invention can be measured, for example, by a method described in Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition of 2013).

To increase the apparent attenuation, it is necessary to vigorously perform fermentation. To vigorously perform fermentation, there are methods such as raising the fermentation temperature, raising the aeration rate (oxygen concentration in wort), and increasing the amount of sugar (assimilable sugar) eaten by the yeast. There is a tendency that when fermentation proceeds vigorously, nitrogen components are removed from the system and the total nitrogen amount decreases, that is, the apparent attenuation and the total nitrogen amount have an inverse correlation. Thus, to control the total nitrogen amount to be greater than or equal to a predetermined value while maintaining the apparent attenuation greater than or equal to 70.0%, the total nitrogen amount and the apparent attenuation can be adjusted to fall within the above-described ranges by, for example, adjusting the malt blend, the hop blend, the preparation conditions, the fermentation conditions, and the like while confirming the influence of adjustment of the total nitrogen amount on the apparent attenuation and the influence of adjustment of the apparent attenuation on the total nitrogen amount.

The total polyphenol amount in the beer-taste beverage according to the fourth aspect of the present invention is preferably greater than or equal to 42 mg/L, more preferably greater than or equal to 50 mg/L, even more preferably greater than or equal to 60 mg/L, still even more preferably greater than or equal to 70 mg/L, more preferably greater than or equal to 80 mg/L, still even more preferably greater than or equal to 90 mg/L, and particularly preferably greater than or equal to 100 mg/L, from the viewpoint of providing a beer-taste beverage having improved good bitterness, crispiness, drinking sensation, robust taste, and savory taste. and may be greater than or equal to 110 mg/L, greater than or equal to 120 mg/L, greater than or equal to 130 mg/L, greater than or equal to 140 mg/L, greater than or equal to 150 mg/L, greater than or equal to 160 mg/L, greater than or equal to 170 mg/L, greater than or equal to 180 mg/L, greater than or equal to 190 mg/L, greater than or equal to 200 mg/L, greater than or equal to 210 mg/L, greater than or equal to 220 mg/L, greater than or equal to 230 mg/L, greater than or equal to 240 mg/L, greater than or equal to 250 mg/L, greater than or equal to 260 mg/L, greater than or equal to 270 mg/L, greater than or equal to 280 mg/L, greater than or equal to 290 mg/L, greater than or equal to 300 mg/L, greater than or equal to 310 mg/L, greater than or equal to 320 mg/L, greater than or equal to 330 mg/L, greater than or equal to 340 mg/L, or greater than or equal to 350 mg/L.

On the other hand, a beverage containing a large amount of total polyphenols has a low turbidity stability and its taste becomes heavy. Thus, the total polyphenol amount in the beverage according to the present invention is preferably less than or equal to 500 mg/L, more preferably less than or equal to 400 mg/L, even more preferably less than or equal to 390 mg/L, still even more preferably less than or equal to 380 mg/L, more preferably less than or equal to 370 mg/L, still even more preferably less than or equal to 360 mg/L, and particularly preferably less than or equal to 350 mg/L, and may be less than or equal to 340 mg/L, less than or equal to 330 mg/L, less than or equal to 320 mg/L, less than or equal to 310 mg/L, less than or equal to 300 mg/L, less than or equal to 290 mg/L, less than or equal to 280 mg/L, less than or equal to 270 mg/L, less than or equal to 260 mg/L, less than or equal to 250 mg/L, less than or equal to 240 mg/L, less than or equal to 230 mg/L, less than or equal to 220 mg/L, less than or equal to 210 mg/L, less than or equal to 200 mg/L, less than or equal to 190 mg/L, less than or equal to 180 mg/L, less than or equal to 170 mg/L, less than or equal to 160 mg/L, less than or equal to 150 mg/L, less than or equal to 140 mg/L, less than or equal to 130 mg/L, less than or equal to 120 mg/L, less than or equal to 110 mg/L, or less than or equal to 100 mg/L.

The polyphenol refers to a compound in which two or more hydrogen atoms of an aromatic hydrocarbon are substituted with hydroxyl groups. Examples of the polyphenol include flavonol, isoflavone, tannin, catechin, quercetin, and anthocyanin.

The “total polyphenol amount” in the present invention is the total amount of these polyphenols contained in the beer-taste beverage.

The total polyphenol amount decreases when the fermentation proceeds vigorously, and thus there is an inverse correlation. Accordingly, to control the total polyphenol amount to be greater than or equal to 50 mg/L and the alcohol content to be greater than or equal to 12.5 (v/v) %, it is necessary to adjust the alcohol content and the total polyphenol amount to fall within the above ranges by adjusting the malt blend, the hop blend, the preparation conditions, the fermentation conditions, and the filtration conditions while confirming the influence of adjustment of the total polyphenol amount on the alcohol content and the influence of adjustment of the alcohol content on the total polyphenol amount.

The total polyphenol amount can be adjusted by appropriately setting the addition of diluting water or carbonated water, the types of raw materials (such as malt, corn grits, and sugar solution), the amounts of raw materials, the type of enzyme, the amount of enzyme added, the timing of enzyme addition, the pH in the preparation tank, the pH in the preparation step (wort production step from feeding of malt until before addition of yeast), the time for wort filtration, the set temperature and holding time in each temperature region in preparation of wort (including during saccharification), the original extract concentration in the pre-fermentation liquid, the original extract concentration in the fermentation step, the fermentation conditions (such as the oxygen concentration, aeration conditions, yeast species, amount of yeast added, the number of yeast grown, removal timing of yeast, fermentation temperature, fermentation time, pressure setting, and carbon dioxide concentration), the cooling timing, the cooling temperature, the cooling time, the form of beer filtration (such as diatomaceous earth, membrane, sheet, cartridge, and filter), the stabilizer added at the time of beer filtration (such as silica gel, polyvinylpolypyrrolidone (PVPP), bentonite, tannin, bentonite), and the like.

In addition, the total polyphenol amount of the beer-taste beverage according to the present invention can be controlled by, for example, (i) adjusting the usage amount of a raw material with a high polyphenol content, such as barley malt or malt husks (hulls), (ii) adjustment of hops, and (iii) performing fermentation vigorously.

As a specific method of (i), the total polyphenol amount can be increased by increasing the usage amount of a raw material with a high polyphenol content, such as malt.

In general, malt with husks (hulls) or the like has high nitrogen and polyphenol contents, and soybeans, yeast extract, peas, corn, processed corn products (such as corn grits), wheat, wheat malt, and the like have a high nitrogen content but a low polyphenol content. Thus, the total nitrogen amount and the total polyphenol amount in the beer-taste beverage can be increased or decreased by adjusting the blending proportion of the raw materials. Hereinafter, representative methods (1) to (4) for increasing or decreasing the total nitrogen amount and the total polyphenol amount will be described.

(1) The total nitrogen amount and the total polyphenol amount of the beer-taste beverage are increased by increasing the amount of malt with husks or the like used.

(2) The total nitrogen amount of the beer-taste beverage is increased or decreased while maintaining the total polyphenol amount by increasing or decreasing the amount of soybeans, yeast extract, or the like used.

(3) The total polyphenol amount is increased while maintaining the total nitrogen amount by increasing the amount of malt with husks or the like used and decreasing the amount of soybeans, yeast extract, or the like used.

(4) The total polyphenol amount is decreased while maintaining the total nitrogen amount by decreasing the amount of malt with husks or the like used and increasing the amount of soybeans, yeast extract, or the like used.

Adjustment of hops of (ii) for controlling the total polyphenol amount is performed by, for example, adjusting the type of hops to be used, the amount of hops to be added, and the timing of hop addition. Performing fermentation vigorously of (iii) for controlling the total polyphenol amount is conducted by, for example, adjusting the fermentation temperature, the type and the amount of yeast used, and the like.

The total polyphenol amount of the beer-taste beverage according to the present invention can be measured, for example, by a method described in Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition of 2013).

Examples of the form of the hops used in the present invention include pellet hops, powdered hops, and hop extract. In addition, the hops used may be a processed hop product, such as isomerized hops or reduced hops.

The amount of hops added is appropriately adjusted and is preferably from 0.0001 to 1 mass % based on the total amount of the beverage. In addition, a beer-taste beverage made using hops as a raw material is a beverage containing iso-α-acid, which is a component derived from hops. The content of iso-α-acid in the beer-taste beverage made using hops is preferably greater than or equal to 5.0 mass ppm, more preferably greater than or equal to 7.0 mass ppm, and even more preferably greater than or equal to 10.0 mass ppm, and may be greater than or equal to 13.0 mass ppm, or greater than or equal to 16.0 mass ppm, based on the total amount (100 mass %) of the beer-taste beverage. The iso-α-acid content of the beer-taste beverage using hops is preferably less than or equal to 100.0 mass ppm, more preferably less than or equal to 95.0 mass ppm, and even more preferably less than or equal to 90.0 mass ppm, and may be less than or equal to 85.0 mass ppm, less than or equal to 80.0 mass ppm, less than or equal to 75.0 mass ppm, less than or equal to 70.0 mass ppm, less than or equal to 65.0 mass ppm, less than or equal to 60.0 mass ppm, less than or equal to 58.0 mass ppm, less than or equal to 56.0 mass ppm, less than or equal to 54.0 mass ppm, less than or equal to 52.0 mass ppm, less than or equal to 50.0 mass ppm, less than or equal to 48.0 mass ppm, less than or equal to 46.0 mass ppm, less than or equal to 44.0 mass ppm, less than or equal to 42.0 mass ppm, less than or equal to 40.0 mass ppm, less than or equal to 38.0 mass ppm, less than or equal to 36.0 mass ppm, less than or equal to 34.0 mass ppm, less than or equal to 32.0 mass ppm, or less than or equal to 30.0 mass ppm based on the total amount (100 mass %) of the beer-taste beverage.

In the present specification, the content of iso-α-acid means a value measured by the high-performance liquid chromatography (HPLC) analysis method described in Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition of 2013).

The bitterness value of the beer-taste beverage according to the present invention is not particularly limited, but is preferably greater than or equal to 5.0 BUs and less than or equal to 80.0 BUs. As used herein, the term “bitterness value” refers to an index of bitterness caused by iso-α-acid such as isohumulone. The bitterness value can be measured in accordance with the method described in “BCOJ Beer Analysis Method (Revised edition on Nov. 1, 2004) 8.15 Bitterness value”. Specifically, the bitterness value (BUs) can be determined by adding an acid to a degassed sample, performing extraction with isooctane, measuring absorbance of the resulting isooctane layer at 275 nm against isooctane, and multiplying the measured absorbance by a factor.

The bitterness value of the beer-taste beverage of the present invention is preferably greater than or equal to 5.0 BUs, more preferably greater than or equal to 10.0 BUs, more preferably greater than or equal to 15.0 BUs, even more preferably greater than or equal to 20.0 BUs, still even more preferably greater than or equal to 22.0 BUs, more preferably greater than or equal to 24.0 BUs, even more preferably greater than or equal to 28.0 BUs, still even more preferably greater than or equal to 30.0 BUS, more preferably greater than or equal to 32.0 BUS, even more preferably greater than or equal to 34.0 BUs, still even more preferably greater than or equal to 36.0 BUs, more preferably greater than or equal to 38.0 BUs, even more preferably greater than or equal to 40.0 BUs, still even more preferably greater than or equal to 42.0 BUS, more preferably greater than or equal to 44.0 BUS, even more preferably greater than or equal to 46.0 BUs, still even more preferably greater than or equal to 48.0 BUs, more preferably greater than or equal to 50.0 BUs, even more preferably greater than or equal to 52.0 BUs, and still even more preferably greater than or equal to 54.0 BUs.

The bitterness value of the beer-taste beverage according to the present invention is preferably less than or equal to 200 BUs, more preferably less than or equal to 150 BUs, even more preferably less than or equal to 100 BUs, still even more preferably less than or equal to 80.0 BUs, more preferably less than or equal to 75.0 BUs, more preferably less than or equal to 70.0 BUs, even more preferably less than or equal to 65.0 BUS, and still even more preferably less than or equal to 60.0 BUs, is less than or equal to 65.0 BUs, less than or equal to 60.0 BUS, less than or equal to 58.0 BUs, or less than or equal to 56.0 BUs, and still even more preferably less than or equal to 54.0 BUs, less than or equal to 52.0 BUs, less than or equal to 50.0 BUS, less than or equal to 48.0 BUs, or less than or equal to 46.0 BUs, and still even more preferably less than or equal to 44.0 BUs, and may be less than or equal to 42.0 BUs, less than or equal to 40.0 BUs, less than or equal to 38.0 BUs, or less than or equal to 36.0 BUs.

The bitterness value depends on the content of iso-α-acid contained in the beverage, and iso-α-acid is a bittering component contained in hops in a large amount. Thus, a beverage having a predetermined bitterness value can be produced by controlling the amount of hops used.

Examples of the sweetener include commercially available saccharified liquids produced by degrading starch derived from grain with an acid, an enzyme, or the like, sucrose, saccharides such as commercially available starch syrup, tri- or higher saccharides, sugar alcohols, isomerized sugars, natural sweeteners such as stevia, and artificial sweeteners.

These saccharides may be in the form of a liquid, such as a solution, or a solid, such as a powder.

In addition, there are no particular limitations on the type of raw material grain for starch, the method of purifying starch, and the conditions for treatment, such as hydrolysis with an enzyme or an acid. For example, a saccharide may be used with the proportion of maltose increased by appropriately setting conditions for hydrolysis with an enzyme or an acid. In addition, sucrose, fructose, glucose, maltose, trehalose, maltotriose, maltotetraose, isomaltose, isomaltotriose, isomaltotetraose, and solutions thereof (sugar solutions) can also be used.

In addition, examples of the artificial sweetener include aspartame, acesulfame potassium (acesulfame K), sucralose, and neotame.

One of these sweeteners may be used alone, or two or more thereof may be used in combination.

Examples of the water-soluble dietary fiber include indigestible dextrin, polydextrose, guar gum degradation products, pectin, glucomannan, alginic acid, laminarin, fucoidin, and carrageenan. From the viewpoint of versatility, such as stability and safety, indigestible dextrin or polydextrose is preferred.

In the beer-taste beverage, the bitterness is preferably imparted by hops or the like, but a bittering agent or a bitterness-imparting agent may be further used.

The bittering agent or bitterness-imparting agent is not particularly limited, and a substance used as a bitterness-imparting agent in ordinary beer and low-malt beer can be used. Examples thereof include Naringin, rosemary, Litchi chinensis, caraway, juniper berry, sage, rosemary, Ganoderma lucidum, bay laurel, Ganoderma lucidum, quassin, citrus extract, bitter wood extract, coffee extract, tea extract, bitter gourd extract, lotus embryo extract, Aloe arborescens extract, rosemary extract, litchi extract, laurel extract, sage extract, caraway extract, Artemisia absinthium extract, absinthin, and alginic acid.

The antioxidant is not particularly limited, and a substance used as an antioxidant in ordinary beer and low-malt beer can be used, and examples thereof include ascorbic acid, erythorbic acid, and catechin.

The flavoring is not particularly limited, and a general beer flavoring can be used. The beer flavoring is used for imparting a beer-like flavor, and contains a brewing component generated by fermentation.

Note that the beer-taste beverage contains ethyl acetate generated by alcoholic fermentation, and the ethyl acetate functions as a flavoring. Thus, when the production process of the beer-taste beverage involves alcoholic fermentation, it is not necessary to separately add a beer flavoring, but a beer flavoring may be added as desired.

As the beer flavoring other than ethyl acetate, esters, higher alcohols, and the like are exemplified, and examples thereof include isoamyl acetate, ethyl acetate, n-propanol, isobutanol, acetaldehyde, ethyl caproate, ethyl caprylate, isoamyl propionate, linalool, geraniol, citral, 4-vinylguaiacol (4-VG), 4-methyl-3-pentenoic acid, 2-methyl-2-pentenoic acid, 1,4-cineol, 1,8-cineol, 2,3-diethyl-5-methylpyrazine, γ-decanolactone, γ-undecalactone, ethyl hexanoate, ethyl 2-methylbutyrate, ethyl n-butyrate, myrcene, citral, limonene, maltol, ethyl maltol, phenylacetic acid, furaneol, furfural, methional, 3-methyl-2-butene-1-thiol, 3-methyl-2-butanethiol, diacetyl, ferulic acid, geranic acid, geranylacetate, ethyl butyrate, octanoic acid, decanoic acid, 9-decenoic acid, nonanoic acid, tetradecanoic acid, propanoic acid, 2-methylpropanoic acid, γ-butyrolactone, 2-aminoacetophenone, ethyl 3-phenylpropionate, 2-ethyl-4-hydroxy-5-methyl-3 (2H)-furanone, dimethylsulfone, 3-methylcyclopentane-1,2-dione, 2-methylbutanal, 3-methylbutanal, 2-methyltetrahydrofuran-3-one, 2-acetylfuran, 2-methyltetrahydrofuran-3-one, hexanal, hexanol, cis-3-hexenal, 1-octen-3-ol, β-eudesmol, 4-mercapto-4-methylpentan-2-one, β-caryophyllene, β-myrcene, furfuryl alcohol, 2-ethylpyrazine, 2,3-dimethylpyrazine, 2-methylbutyl acetate, isoamyl alcohol, 5-hydroxymethylfurfural, phenylacetaldehyde, 1-phenyl-3-butene-1-one, trans-2-hexenal, nonanal, and phenethyl alcohol.

The concentration of the ester or the higher alcohol in the beer-taste beverage according to the present invention can be controlled by appropriately setting the addition of diluting water or carbonated water, the sugar composition and amino acid composition of the pre-fermentation liquid before addition of yeast, sugar concentration, amino acid concentration, original extract concentration in the pre-fermentation liquid, yeast species, fermentation conditions (such as oxygen concentration, aeration conditions, yeast species, amount of yeast added, the number of yeast grown, yeast removal timing, fermentation temperature, fermentation time, pressure setting, and carbon dioxide concentration), cooling timing, and the like.

The acidulant is not particularly limited as long as it is a substance with a sour taste, and examples thereof include phosphoric acid, citric acid, gluconic acid, tartaric acid, lactic acid, malic acid, phytic acid, acetic acid, succinic acid, glucono-delta-lactone, and salts thereof.

Among these acidulants, phosphoric acid, citric acid, gluconic acid, tartaric acid, lactic acid, malic acid, phytic acid, acetic acid, succinic acid, or a salt thereof is preferable, phosphoric acid, citric acid, lactic acid, tartaric acid, acetic acid, or a salt thereof is more preferable, and phosphoric acid or a phosphate is particularly preferable. One of these acidulants may be used alone, or two or more of these acidulants may be used in combination.

In the beer-taste beverage according to the present invention, the inclusion of phosphoric acid or a phosphate does not particularly affect the suppression of the feeling of fullness unsuitable for the beer-taste beverage, but it is possible not to impart unsuitable sourness to the beverage while ensuring microbial assurance by lowering the pH.

Further, to make the beer-taste beverage have a clearer taste, the content of phosphoric acid in the beer-taste beverage according to the first aspect of the present invention is preferably greater than or equal to 300 mass ppm, more preferably greater than or equal to 350 mass ppm, even more preferably greater than or equal to 400 mass ppm, still even more preferably greater than or equal to 450 mass ppm, and particularly preferably greater than or equal to 500 mass ppm, and may be greater than or equal to 550 mass ppm, greater than or equal to 600 mass ppm, greater than or equal to 650 mass ppm, greater than or equal to 700 mass ppm, greater than or equal to 750 mass ppm, greater than or equal to 800 mass ppm, greater than or equal to 850 mass ppm, greater than or equal to 900 mass ppm, greater than or equal to 950 mass ppm, greater than or equal to 1000 mass ppm, greater than or equal to 1050 mass ppm, greater than or equal to 1100 mass ppm, greater than or equal to 1150 mass ppm, greater than or equal to 1200 mass ppm, greater than or equal to 1250 mass ppm, greater than or equal to 1300 mass ppm, greater than or equal to 1350 mass ppm, greater than or equal to 1400 mass ppm, greater than or equal to 1450 mass ppm, or greater than or equal to 1500 mass ppm.

Not to impart unsuitable sourness to the beer-taste beverage, the content of phosphoric acid in the beer-taste beverage according to the first aspect of the present invention is preferably less than or equal to 3000 mass ppm, more preferably less than or equal to 2800 mass ppm, even more preferably less than or equal to 2600 mass ppm, still even more preferably less than or equal to 2500 mass ppm, still even more preferably less than or equal to 2400 mass ppm, even more preferably less than or equal to 2300 mass ppm, still even more preferably less than or equal to 2200 mass ppm, still even more preferably less than or equal to 2100 mass ppm, and particularly preferably less than or equal to 2000 mass ppm, and may be less than or equal to 1950 mass ppm, less than or equal to 1900 mas ppm, less than or equal to 1850 mas ppm, less than or equal to 1800 mas ppm, less than or equal to 1750 mas ppm, less than or equal to 1700 mas ppm, less than or equal to 1650 mas ppm, less than or equal to 1600 mas ppm, less than or equal to 1550 mas ppm, less than or equal to 1500 mas ppm, less than or equal to 1450 mas ppm, less than or equal to 1400 mas ppm, less than or equal to 1350 mas ppm, or less than or equal to 1300 mas ppm.

The content of phosphoric acid in the beer-taste beverage of the present invention can be measured by, for example, high-performance liquid chromatography.

Examples of the preservative include benzoic acid; benzoates, such as sodium benzoate; benzoate esters, such as propyl parahydroxybenzoate and butyl parahydroxybenzoate; and dimethyl dicarbonate. In addition, for the preservative, a commercially available preparation, such as Kyohryoku Sanpurezah (Powerful Sanplezer) (a mixture of sodium benzoate and butyl benzoate, available from San-Ei Gen F.F.I., Inc.) may be used. One of these preservatives may be used alone, or two or more of these preservatives may be used in combination.

The content of the preservative is preferably 5 to 1200 mass ppm, more preferably 10 to 1100 mass ppm, even more preferably 15 to 1000 mass ppm, and still even more preferably 20 to 900 mass ppm.

Examples of the salt include sodium chloride, acid potassium phosphate, acid calcium phosphate, ammonium phosphate, magnesium sulfate, calcium sulfate, potassium metabisulfite, calcium chloride, magnesium chloride, potassium nitrate, ammonium sulfate, potassium chloride, monosodium citrate, disodium citrate, and trisodium citrate.

One of these salts may be used alone, or two or more of these salts may be used in combination.

### 1.2 Carbonic Acid Gas

As the carbonic acid gas contained in the beer-taste beverage according to the present invention, carbonic acid gas contained in a raw material may be used, or carbonic acid gas may be dissolved by mixing with carbonated water, addition of carbonic acid gas, or the like.

The beer-taste beverage according to the present invention is subjected to alcoholic fermentation, and thus, the carbonic acid gas generated in the fermentation step can be used as it is, but the amount of the carbonic acid gas may be adjusted by appropriately adding carbonated water.

The carbonic acid gas concentration of the beer-taste beverage according to the present invention is preferably greater than or equal to 0.20 (w/w) %, more preferably greater than or equal to 0.25 (w/w) %, preferably greater than or equal to 0.30 (w/w) %, more preferably greater than or equal to 0.35 (w/w) %, even more preferably greater than or equal to 0.40 (w/w) %, still even more preferably greater than or equal to 0.42 (w/w) %, and particularly preferably greater than or equal to 0.45 (w/w) %, and preferably less than or equal to 0.80 (w/w) %, more preferably less than or equal to 0.70 (w/w) %, even more preferably less than or equal to 0.60 (w/w) %, still even more preferably less than or equal to 0.57 (w/w), and particularly preferably less than or equal to 0.55 (w/w) %.

Note that in the present specification, the carbonic acid gas concentration can be measured by immersing a container containing a target beverage in a water bath at 20° C. for 30 minutes or longer with occasional shaking of the container to adjust the beverage to 20° C. and then using a gas volume measuring device (e.g., such as GVA-500 (available from Kyoto Electronics Manufacturing Co., Ltd.)).

In a case where the beer-taste beverage according to the present invention is a packaged beverage, the carbonic acid gas pressure of the packaged beverage only needs to be appropriately adjusted such that the carbonic acid gas concentration is in the range described above, and is less than or equal to 5.0 kg/cm², less than or equal to 4.5 kg/cm², or less than or equal to 4.0 kg/cm², and greater than or equal to 0.20 kg/cm², greater than or equal to 0.50 kg/cm², or greater than or equal to 1.0 kg/cm². Any of these upper and lower limits may be combined. For example, the carbonic acid gas pressure of the beverage may be greater than or equal to 0.20 kg/cm² and less than or equal to 5.0 kg/cm², greater than or equal to 0.50 kg/cm² and less than or equal to 4.5 kg/cm², or greater than or equal to 1.0 kg/cm² and less than or equal to 4.0 kg/cm².

In the present specification, the gas pressure refers to the gas pressure in the container except in special cases.

The pressure can be measured by a method well-known to those skilled in the art, for example, using a method in which a sample adjusted to 20° C. is fixed to a gas internal pressure meter, the stopcock of the gas internal pressure meter is opened once to release the gas, the stopcock is closed again, the gas internal pressure meter is shaken, and a value when the pointer reaches a certain position is read; or using a commercially available gas pressure measuring device.

### 1.3 Additional Additive

To the beer-taste beverage according to the present invention, an additive of various types may be added as necessary to the extent that the effects of the present invention are not hindered.

Examples of such an additive include colorants; foam-forming agents; fermentation promoters; yeast extract; protein-based substances, such as peptide-containing substances; and seasonings, such as amino acids.

The colorant is used to impart a beer-like color to the beverage, and a caramel dye and/or the like can be used. The foam-forming agent is used to form beer-like foam or to keep the foam of the beverage, and a plant-extracted saponin-based substance, such as soybean saponin and/or quillaja saponin; a plant protein, such as corn and/or soybean; and a peptide-containing substance, such as a collagen peptide; a yeast extract; raw materials derived from milk; and/or the like can be appropriately used.

The fermentation promoter is used to promote fermentation by yeast. For example, a yeast extract; a bran component of rice, wheat, or the like; a vitamin; a mineral agent; and/or the like can be used alone or in combination.

### 1.4 Packaged Beverage

The beer-taste beverage according to the present invention may be a packaged beverage packaged in a container. For the packaged beverage, a container of any form and material may be used, and examples of the container include a bottle, a can, a barrel, or a PET bottle. In particular, from the viewpoint of easy portability, the container is preferably a can, a bottle, or a PET bottle.

### 2 Method for Producing Beer-Taste Beverage

### 2.1 Method for Producing Beer-Taste Beverage According to First Aspect of Present Invention

A method for producing a fermented beer-taste beverage according to the first aspect of the present invention includes the following steps (1) to (3):
(1) performing at least one treatment of saccharification treatment, boiling treatment, and solid content removal treatment on a raw material to produce a pre-fermentation liquid;
(2) cooling the pre-fermentation liquid formed in (1) to produce a cooled pre-fermentation liquid; and
(3) adding yeast to the cooled pre-fermentation liquid produced in step (2) to perform fermentation in such a manner that the apparent attenuation is greater than or equal to 70.0% (fermentation step).

In the method for producing a fermented beer-taste beverage, the original extract concentration, the content of phosphoric acid, the pH, the alcohol content, the chromaticity, and the like can be adjusted at any one or more timings of (i) to (v) below:
(i): before step (1);
(ii): simultaneously with at least one of step (1), step (2), and step (3);
(iii): between step (1) and step (2);
(iv): between step (2) and step (3); and
(v): after step (3).

The content of phosphoric acid may be adjusted by directly blending phosphoric acid or by adjusting the blending amounts of raw materials containing phosphoric acid. In a case where the content of phosphoric acid are too high, water or carbonated water may be added for adjustment.

### Step (1)

Step (1) is a step of performing at least one treatment of saccharification treatment, boiling treatment, and solid content removal treatment using various raw materials to produce a pre-fermentation liquid.

For example, in the case of using malt as a raw material, various raw materials including water and malt are fed in a preparation kettle or a preparation tank, and an enzymatic agent that promotes a change of a component derived from the raw material, such as a polysaccharide degrading enzyme or a proteolytic enzyme, may be added as necessary before fermentation.

Examples of the enzymatic agent include amylase, protease, purine nucleosidase, deaminase, polyphenol oxidase, glucanase, xylanase, pectinase, cellulase, lipase, glucosidase, xanthine oxidase, and transglucosidase. Examples also include enzymatic agents falling under “(3) Following Enzymatic Agents Added During Brewing Step for Purpose of Rationalization of Brewing and the like” in Article 3 “7. Articles Not Handled as Raw Materials for Alcoholic Beverages” of the Notice on the Liquor Tax Law and the Administrative Ordinance Related to Alcoholic Beverages (revised on Jun. 27, 2018).

Adding these enzymatic agents can efficiently adjust the component composition of the resulting fermented beer-taste beverage. As various raw materials other than malt, hops, a preservative, a sweetener, a water-soluble dietary fiber, a bittering agent or bitterness-imparting agent, an antioxidant, a flavoring, an acidulant, a salt, and/or the like may be added. These raw materials may be added before performing the saccharification treatment, during the saccharification treatment, or after completion of the saccharification treatment. In addition, these raw materials may be added during or after the alcoholic fermentation in the next step.

A mixture of the various raw materials is heated to saccharify the starch of the raw materials to perform saccharification treatment.

The temperature and time of the saccharification treatment are preferably appropriately adjusted in view of the type of malt used, the malt proportion, raw materials other than water and malt, the type and amount of the enzyme used, the original extract concentration of the beverage finally produced, and the like. In the present invention, from the viewpoint of adjusting the apparent attenuation of the beer-taste beverage in the above range, the temperature of the saccharification treatment is preferably from 55 to 75° C., and the saccharification treatment is performed preferably for 15 to 240 minutes. After the saccharification treatment, filtration is performed, resulting in the formation of a saccharified liquid.

The saccharified liquid is preferably subjected to boiling treatment.

When this boiling treatment is performed, hops, a bittering agent, and the like are preferably added in the case of using them as raw materials. Hops, a bittering agent, and/or the like may be added between the start of boiling the saccharified liquid and a time point before the completion of the boiling.

Instead of the saccharified liquid, a pre-fermentation liquid may be prepared by adding hops, a bittering agent, and/or the like to a mixture obtained by adding warm water to a malt extract, and boiling the mixture.

In addition, in the case without using malt, a pre-fermentation liquid may be prepared by mixing, as the raw materials, a liquid sugar containing a carbon source; a nitrogen source as an amino acid-containing raw material other than barley or malt; hops; a preservative; a sweetener; a water-soluble dietary fiber; a bittering agent or a bitterness-imparting agent; an antioxidant; a flavoring; an acidulant; a salt; and/or the like together with warm water to prepare a liquid sugar solution, and boiling the liquid sugar solution.

In the case of using hops, it may be added before the boiling treatment or may be added between the start of boiling the liquid sugar solution and before the completion of the boiling.

### Step (2)

Step (2) is a step of cooling the pre-fermentation liquid produced in step (1) to produce a cooled pre-fermentation liquid.

After the completion of the boiling treatment, the pre-fermentation liquid is transferred to a whirlpool and cooled to 0 to 23° C. After the cooling, solid contents, such as coagulated protein, may be removed to adjust the original extract concentration.

Through such treatment, a cooled pre-fermentation liquid is produced.

### Step (3)

Step (3) is a step of adding yeast to the cooled pre-fermentation liquid produced in step (2) to perform alcoholic fermentation.

The yeast used in this step can be appropriately selected in view of the type of the fermented beverage to be produced, the target flavor, the fermentation conditions, and the like, and top-fermenting yeast may be used, or bottom-fermenting yeast may be used.

The yeast in the form of a yeast suspension as is may be added to raw materials, or a slurry produced by concentrating the yeast by centrifugation or sedimentation may be added to the pre-fermentation liquid. Alternatively, a material from which the supernatant has been completely removed after the centrifugation may be added. The amount of yeast added to a stock solution can be appropriately set and is, for example, appropriately from 5×10⁶ cells/mL to 1×10⁸ cells/mL.

Various conditions, such as the fermentation temperature and the fermentation period, for performing alcoholic fermentation are set to achieve the apparent attenuation greater than or equal to 70.0%, and fermentation may be performed, for example, under conditions of 8 to 25° C. for 5 to 10 days. During the fermentation step, the temperature (temperature increase or temperature decrease) or pressure of the fermented liquid may be changed.

The apparent attenuation of the beer-taste beverage can be adjusted by appropriately setting the type, amount, and timing of addition of the polysaccharide degrading enzyme such as transglucosidase. It can be also adjusted by changing the temperature (temperature increase or temperature decrease) or pressure of the fermented liquid during the fermentation step.

In addition, after completion of this step, the yeast may be removed with a filter or the like, and water or an additive, such as a flavoring, an acidulant, or a dye, may be added as necessary.

After these steps, a step performed in the production of a beer-taste beverage known to those skilled in the art, such as a step of storing an alcoholic beverage and a filtration step, may be performed.

The fermented beer-taste beverage thus produced is filled in a predetermined container and distributed to the market as a product.

The method of packaging the fermented beer-taste beverage is not particularly limited, and a packaging method known to those skilled in the art can be used. Through the packaging step, the fermented beer-taste beverage is filled and sealed in a container. In the packaging step, a container of any form and material may be used, and examples of the container are as described above.

### 2.2 Method for Producing Beer-Taste Beverage According to Second Aspect of Present Invention

### 2.2.1 Method for Producing Fermented Beer-Taste Beverage

A method for producing a fermented beer-taste beverage according to the second aspect of the present invention includes the following steps (1) to (3):
(1) performing at least one treatment of saccharification treatment, boiling treatment, and solid content removal treatment on a raw material to produce a pre-fermentation liquid;
(2) cooling the pre-fermentation liquid formed in (1) to produce a cooled pre-fermentation liquid; and
(3) adding yeast to the cooled pre-fermentation liquid produced in step (2) to perform fermentation (fermentation step).

In the method for producing a fermented beer-taste beverage, the real extract concentration, alcohol content, chromaticity, content of free amino nitrogen, and the like can be adjusted at one or more timings of (i) to (v) below, but the adjusting step is not essential:
(i): before step (1);
(ii): simultaneously with at least one of step (1), step (2), and step (3);
(iii): between step (1) and step (2);
(iv): between step (2) and step (3); and
(v): after step (3).

### Step (1)

Step (1) is a step of performing at least one treatment of saccharification treatment, boiling treatment, and solid content removal treatment using various raw materials to produce a pre-fermentation liquid.

For example, in the case of using malt as a raw material, various raw materials including water and malt are fed in a preparation kettle or a preparation tank, and an enzymatic agent that promotes a change of a component derived from the raw material, such as a polysaccharide degrading enzyme or a proteolytic enzyme, may be added as necessary before fermentation.

Examples of the enzymatic agent include amylase, protease, purine nucleosidase, deaminase, polyphenol oxidase, glucanase, xylanase, pectinase, cellulase, lipase, glucosidase, xanthine oxidase, and transglucosidase. Examples also include enzymatic agents falling under “(3) Following Enzymatic Agents Added during Brewing Step for Purpose of Rationalization of Brewing and the like” in Article 3 “7. Articles not Handled as Raw Materials for Alcoholic Beverages” of the Notice on the Liquor Tax Law and the Administrative Ordinance Related to Alcoholic Beverages (revised on Jun. 27, 2018).

Adding these enzymatic agents can efficiently adjust the component composition of the resulting fermented beer-taste beverage. As various raw materials other than malt, hops, a preservative, a sweetener, a water-soluble dietary fiber, a bittering agent or bitterness-imparting agent, an antioxidant, a flavoring, an acidulant, a salt, and/or the like may be added. These raw materials may be added before performing the saccharification treatment, during the saccharification treatment, or after completion of the saccharification treatment. In addition, these raw materials may be added during or after the alcoholic fermentation in the next step.

A mixture of the various raw materials is heated to saccharify the starch of the raw materials to perform saccharification treatment.

The temperature and time of the saccharification treatment are preferably appropriately adjusted in view of the type of malt used, the malt proportion, raw materials other than water and malt, the type and amount of the enzyme used, the original extract concentration of the beverage finally produced, and the like. In the second aspect of the present invention, from the viewpoint of adjusting the real extract concentration of the beer-taste beverage to be less than or equal to 11.8 mass % and the alcohol content to be greater than or equal to 9.2 (v/v) %, the temperature of the saccharification treatment is preferably from 55 to 75° C., and the saccharification treatment is performed preferably for 15 to 240 minutes. After the saccharification treatment, filtration is performed, resulting in the formation of a saccharified liquid.

The saccharified liquid is preferably subjected to boiling treatment.

When this boiling treatment is performed, hops, a bittering agent, and the like are preferably added in the case of using them as raw materials. Hops, a bittering agent, and/or the like may be added between the start of boiling the saccharified liquid and a time point before the completion of the boiling.

Instead of the saccharified liquid, a pre-fermentation liquid may be prepared by adding hops, a bittering agent, and/or the like to a mixture obtained by adding warm water to a malt extract, and boiling the mixture.

In addition, in the case without using malt, a pre-fermentation liquid may be prepared by mixing, as the raw materials, a liquid sugar containing a carbon source; a nitrogen source as an amino acid-containing raw material other than barley or malt; hops; a preservative; a sweetener; a water-soluble dietary fiber; a bittering agent or a bitterness-imparting agent; an antioxidant; a flavoring; an acidulant; a salt; and/or the like together with warm water to prepare a liquid sugar solution, and boiling the liquid sugar solution.

In the case of using hops, it may be added before the boiling treatment or may be added between the start of boiling the liquid sugar solution and before the completion of the boiling.

### Step (2)

Step (2) is a step of cooling the pre-fermentation liquid produced in step (1) to produce a cooled pre-fermentation liquid.

After the completion of the boiling treatment, the pre-fermentation liquid is transferred to a whirlpool and cooled to 0 to 23° C. After the cooling, solid contents, such as coagulated protein, may be removed to adjust the original extract concentration.

Through such treatment, a cooled pre-fermentation liquid is produced.

### Step (3)

Step (3) is a step of adding yeast to the cooled pre-fermentation liquid produced in step (2) to perform alcoholic fermentation.

The yeast used in this step can be appropriately selected in view of the type of the fermented beverage to be produced, the target flavor, the fermentation conditions, and the like, and top-fermenting yeast may be used, or bottom-fermenting yeast may be used.

The yeast in the form of a yeast suspension as is may be added to raw materials, or a slurry produced by concentrating the yeast by centrifugation or sedimentation may be added to the pre-fermentation liquid. Alternatively, a material from which the supernatant has been completely removed after the centrifugation may be added. The amount of yeast added to a stock solution can be appropriately set and is, for example, appropriately from 5×10⁶ cells/mL to 1×10⁸ cells/mL.

Various conditions such as the fermentation temperature and the fermentation period during the alcoholic fermentation are set in such a manner that the real extract concentration of the resulting beverage is less than or equal to 11.8 mass % and the alcohol content is greater than or equal to 10.5 (v/v) %. The fermentation temperature can be, for example, 8 to 25° C., and the fermentation period can be, for example, 5 to 10 days. Further, during the fermentation step, the temperature (temperature increase or temperature decrease) or pressure of the fermented liquid may be changed.

The real extract concentration and the alcohol content of the beer-taste beverage can be adjusted by, for example, the following method.

(i) The type, amount, and timing of addition of a polysaccharide degrading enzyme, such as amylase or transglucosidase, and an isomerase are appropriately set.

(ii) During the fermentation step, the temperature (temperature increase or temperature decrease) or pressure of the fermented liquid are changed.

(iii) Aeration is performed during fermentation to control the dissolved oxygen content of the fermented liquid.

After these steps (1) to (3), a step performed in the production of a beer-taste beverage known to those skilled in the art, such as a step of storing an alcoholic beverage and a filtration step, may be performed. In addition, after these steps (1) to (3), the yeast may be removed with a filter or the like, and water or an additive, such as a flavoring, an acidulant, a dye, or an alcohol raw material, may be added as necessary.

Further, as necessary, a sterilization step may be provided before or after filling into a predetermined container, or both before and after filling.

The fermented beer-taste beverage thus produced is filled in a predetermined container and distributed to the market as a product.

The method of packaging the fermented beer-taste beverage is not particularly limited, and a packaging method known to those skilled in the art can be used. Through the packaging step, the fermented beer-taste beverage is filled and sealed in a container. In the packaging step, a container of any form and material may be used, and examples of the container are as described above.

### 2.2.2 Method for Producing Non-Fermented Beer-Taste Beverage

A method for producing a non-fermented beer-taste beverage according to the second aspect of the present invention is not particularly limited, and is the same as a general method for producing a non-fermented beer-taste beverage except that the real extract concentration, the alcohol content, and the like are controlled.

As an example of a method for producing a stock solution of a non-fermented beer-taste beverage, first, predetermined amounts of wort, a sweetening substance, a flavoring, and other components are mixed to prepare a blend. Next, a predetermined amount of drinking water is added to the blend to prepare a primary raw material liquid. After boiling the primary raw material liquid, an alcoholic beverage is added and carbonated water is added by a carbonation process.

The alcoholic beverage to be added is not particularly limited, and examples thereof include spirits (liquor) such as alcohol as raw material, shochu, awamori, whisky, brandy, vodka, rum, tequila, and gin, and brewer's alcohol.

As necessary, a precipitate can be separated and removed by filtration, centrifugation, or the like in each step. Alternatively, carbonated water may be added after the raw material liquid is prepared in a concentrated state. A non-fermented beverage can be easily prepared by using a normal production process of a soft drink without a fermentation facility.

It is more desirable to remove the precipitate before the carbonation step or the carbonated water addition step because the causative substances of lees and off-flavor can be removed.

The beer-taste beverage thus produced according to the second aspect of the present invention is filled in a predetermined container and distributed to the market as a product.

The method of packaging the beer-taste beverage is not particularly limited, and a packaging method known to those skilled in the art can be used. Through the packaging step, the beer-taste beverage according to the present invention is filled and sealed in a container. In the packaging step, a container of any form and material may be used, and examples of the container include containers described in “1.4 Packaged beverage”.

### 2.3 Method for Producing Beer-Taste Beverage According to Third Aspect of Present Invention

A method for producing a beer-taste beverage according to the third aspect of the present invention includes the following steps (1) to (3):
(1) performing at least one treatment of saccharification treatment, boiling treatment, and solid content removal treatment on a raw material to produce a pre-fermentation liquid;
(2) cooling the pre-fermentation liquid formed in (1) to produce a cooled pre-fermentation liquid; and
(3) adding yeast to the cooled pre-fermentation liquid produced in step (2) to perform fermentation in such a manner that the apparent attenuation is greater than or equal to 70.0% (fermentation step).

In the method for producing a beer-taste beverage, the total nitrogen amount, alcohol content, and pH can be adjusted at one or more timings of (i) to (v) below, but the adjustment step is not essential:
(i): before step (1);
(ii): simultaneously with at least one of step (1), step (2), and step (3);
(iii): between step (1) and step (2);
(iv): between step (2) and step (3); and
(v): after step (3).

The method for producing a beer-taste beverage according to the third aspect of the present invention may include at least one of an ethanol addition step and an ethanol-containing composition addition step for adjusting the alcohol content, or need not include the ethanol addition step or the ethanol-containing composition addition step.

The ethanol composition to be added in the ethanol addition step and the ethanol-containing composition addition step is not particularly limited, and examples thereof include spirits (liquor) such as alcohol as raw material, shochu, awamori, whisky, brandy, vodka, rum, tequila, and gin, and brewer's alcohol.

### Step (1), Step (2)

Step (1) and step (2) in the method for producing a beer-taste beverage according to the third aspect of the present invention are the same as step (1) and step (2) in the method for producing a beer-taste beverage according to the first aspect of the present invention.

### Step (3)

Step (3) is a step of adding yeast to the cooled pre-fermentation liquid produced in step (2) to perform alcoholic fermentation.

The yeast used in this step can be appropriately selected in view of the type of the fermented beverage to be produced, the target flavor, the fermentation conditions, and the like, and top-fermenting yeast may be used, or bottom-fermenting yeast may be used.

The yeast in the form of a yeast suspension as is may be added to raw materials, or a slurry produced by concentrating the yeast by centrifugation or sedimentation may be added to the pre-fermentation liquid. Alternatively, a material from which the supernatant has been completely removed after the centrifugation may be added. The amount of yeast added to a stock solution can be appropriately set and is, for example, appropriately from 5×10⁶ cells/mL to 1×10⁸ cells/mL.

Various conditions, such as the fermentation temperature and the fermentation period, for performing alcoholic fermentation are set to achieve the apparent attenuation greater than or equal to 70.0%, and fermentation may be performed, for example, under conditions of 8 to 25° C. for 5 to 10 days. During the fermentation step, the temperature (temperature increase or temperature decrease) or pressure of the fermented liquid may be changed.

The apparent attenuation of the beer-taste beverage can be adjusted by appropriately setting the type, amount, and timing of addition of the polysaccharide degrading enzyme such as transglucosidase. It can be also adjusted by changing the temperature (temperature increase or temperature decrease) or pressure of the fermented liquid during the fermentation step.

In addition, after completion of this step, the yeast may be removed with a filter or the like, and water or an additive, such as a flavoring, an acidulant, or a dye, may be added as necessary.

To reduce the alcohol content, carbonated water may be added by the carbonation step.

After steps (1) to (3), a step performed in the production of a beer-taste beverage known to those skilled in the art, such as a step of storing an alcoholic beverage and a filtration step, may be performed.

The fermented beer-taste beverage thus produced is filled in a predetermined container and distributed to the market as a product.

The method of packaging the fermented beer-taste beverage is not particularly limited, and a packaging method known to those skilled in the art can be used. Through the packaging step, the fermented beer-taste beverage is filled and sealed in a container. In the packaging step, a container of any form and material may be used, and examples of the container are as described above.

### 2.4 Method for Producing Beer-Taste Beverage According to Fourth Aspect of Present Invention

### 2.4.1 Method for Producing Fermented Beer-Taste Beverage

A method for producing a fermented beer-taste beverage according to the fourth aspect of the present invention includes the following steps (1) to (3):
(1) performing at least one treatment of saccharification treatment, boiling treatment, and solid content removal treatment on a raw material to produce a pre-fermentation liquid;
(2) cooling the pre-fermentation liquid formed in (1) to produce a cooled pre-fermentation liquid; and
(3) adding yeast to the cooled pre-fermentation liquid produced in step (2) to perform fermentation (fermentation step).

In the method for producing a fermented beer-taste beverage, the alcohol content, the original extract concentration, the total polyphenol amount, the pH, and the like can be adjusted at any one or more timings of (i) to (v) below, but the adjusting step is not essential:
(i): before step (1);
(ii): simultaneously with at least one of step (1), step (2), and step (3);
(iii): between step (1) and step (2);
(iv): between step (2) and step (3); and
(v): after step (3).

The method for producing a fermented beer-taste beverage according to the fourth aspect of the present invention may include at least one of the ethanol addition step and the ethanol-containing composition addition step to adjust the alcohol content, or need not include the ethanol addition step or the ethanol-containing composition addition step.

The ethanol composition to be added in the ethanol addition step and the ethanol-containing composition addition step is not particularly limited, and examples thereof include spirits (liquor) such as alcohol as raw material, shochu, awamori, whisky, brandy, vodka, rum, tequila, and gin, and brewer's alcohol.

### Step (1)

Step (1) is a step of performing at least one treatment of saccharification treatment, boiling treatment, and solid content removal treatment using various raw materials to produce a pre-fermentation liquid.

For example, in the case of using malt as a raw material, various raw materials including water and malt are fed in a preparation kettle or a preparation tank, and an enzymatic agent that promotes a change of a component derived from the raw material, such as a polysaccharide degrading enzyme or a proteolytic enzyme, may be added as necessary before fermentation.

Examples of the enzymatic agent include amylase, protease, purine nucleosidase, deaminase, polyphenol oxidase, glucanase, xylanase, pectinase, cellulase, lipase, glucosidase, glucoamylase, xanthine oxidase, and transglucosidase. Examples also include enzymatic agents falling under “(3) Following Enzymatic Agents Added during Brewing Step for Purpose of Rationalization of Brewing and the like” in Article 3 “7. Articles not Handled as Raw Materials for Alcoholic Beverages” of the Notice on the Liquor Tax Law and the Administrative Ordinance Related to Alcoholic Beverages (revised on Jun. 27, 2018).

Adding these enzymatic agents can efficiently adjust the component composition of the resulting fermented beer-taste beverage. As various raw materials other than malt, hops, a preservative, a sweetener, a water-soluble dietary fiber, a bittering agent or bitterness-imparting agent, an antioxidant, a flavoring, an acidulant, a salt, and/or the like may be added. These raw materials may be added before performing the saccharification treatment, during the saccharification treatment, or after completion of the saccharification treatment. In addition, these raw materials may be added during or after the alcoholic fermentation in the next step.

A mixture of the various raw materials is heated to saccharify the starch of the raw materials to perform saccharification treatment.

The temperature and time of the saccharification treatment are preferably appropriately adjusted in view of the type of malt used, the malt proportion, raw materials other than water and malt, the type and amount of the enzyme used, the original extract concentration of the beverage finally produced, and the like. In the fourth aspect of the present invention, from the viewpoint of adjusting the alcohol content of the beer-taste beverage, the temperature of the saccharification treatment is preferably from 55 to 75° C., and the saccharification treatment is performed preferably for 15 to 240 minutes. After the saccharification treatment, filtration is performed, resulting in the formation of a saccharified liquid.

The saccharified liquid is preferably subjected to boiling treatment.

When this boiling treatment is performed, hops, a bittering agent, and the like are preferably added in the case of using them as raw materials. Hops, a bittering agent, and/or the like may be added between the start of boiling the saccharified liquid and a time point before the completion of the boiling.

Instead of the saccharified liquid, a pre-fermentation liquid may be prepared by adding hops, a bittering agent, and/or the like to a mixture obtained by adding warm water to a malt extract, and boiling the mixture.

In addition, in the case without using malt, a pre-fermentation liquid may be prepared by mixing, as the raw materials, a liquid sugar containing a carbon source; a nitrogen source as an amino acid-containing raw material other than barley or malt; hops; a preservative; a sweetener; a water-soluble dietary fiber; a bittering agent or a bitterness-imparting agent; an antioxidant; a flavoring; an acidulant; a salt; and/or the like together with warm water to prepare a liquid sugar solution, and boiling the liquid sugar solution.

In the case of using hops, it may be added before the boiling treatment or may be added between the start of boiling the liquid sugar solution and before the completion of the boiling.

### Step (2)

Step (2) is a step of cooling the pre-fermentation liquid produced in step (1) to produce a cooled pre-fermentation liquid.

After the completion of the boiling treatment, the pre-fermentation liquid is transferred to a whirlpool and cooled to 0 to 23° C. After the cooling, solid contents, such as coagulated protein, may be removed to adjust the original extract concentration.

Through such treatment, a cooled pre-fermentation liquid is produced.

### Step (3)

Step (3) is a step of adding yeast to the cooled pre-fermentation liquid produced in step (2) to perform alcoholic fermentation.

The yeast used in this step can be appropriately selected in view of the type of the fermented beverage to be produced, the target flavor, the fermentation conditions, and the like, and top-fermenting yeast may be used, or bottom-fermenting yeast may be used.

The yeast in the form of a yeast suspension as is may be added to raw materials, or a slurry produced by concentrating the yeast by centrifugation or sedimentation may be added to the pre-fermentation liquid. Alternatively, a material from which the supernatant has been completely removed after the centrifugation may be added. The amount of yeast added to a stock solution can be appropriately set and is, for example, appropriately from 5×10⁶ cells/mL to 1×10⁸ cells/mL.

As various conditions, such as the fermentation temperature and the fermentation period, for performing alcoholic fermentation, fermentation may be performed, for example, under conditions of 8 to 25° C. for 5 to 10 days. During the fermentation step, the temperature (temperature increase or temperature decrease) or pressure of the fermented liquid may be changed.

The alcohol content of the fermented beer-taste beverage can be adjusted by appropriately setting the type, amount, and timing of addition of the polysaccharide degrading enzyme such as transglucosidase. It can be also adjusted by changing the temperature (temperature increase or temperature decrease) or pressure of the fermented liquid during the fermentation step.

In addition, after completion of this step, the yeast may be removed with a filter or the like, and water or an additive, such as a flavoring, an acidulant, or a dye, may be added as necessary.

To reduce the alcohol content, carbonated water may be added by the carbonation step.

After steps (1) to (3), a step performed in the production of a beer-taste beverage known to those skilled in the art, such as a step of storing an alcoholic beverage and a filtration step, may be performed.

The fermented beer-taste beverage thus produced is filled in a predetermined container and distributed to the market as a product.

The method of packaging the fermented beer-taste beverage is not particularly limited, and a packaging method known to those skilled in the art can be used. Through the packaging step, the fermented beer-taste beverage is filled and sealed in a container. In the packaging step, a container of any form and material may be used, and examples of the container are as described above.

### 2.4.2 Method for Producing Non-Fermented Beer-Taste Beverage

A method for producing a non-fermented beer-taste beverage according to the fourth aspect of the present invention is not particularly limited, and is the same as a general method for producing a non-fermented beer-taste beverage except that the original extract concentration, the alcohol content, and the like are controlled.

As an example of a method for producing a stock solution of a non-fermented beer-taste beverage, first, predetermined amounts of wort, a sweetening substance, a flavoring, and other components are mixed to prepare a blend. Next, a predetermined amount of drinking water is added to the blend to prepare a primary raw material liquid. After boiling the primary raw material liquid, ethanol or an ethanol composition such as an alcohol beverage is added, and carbonated water is added by the carbonation step.

As necessary, a precipitate can be separated and removed by filtration, centrifugation, or the like in each step. Alternatively, carbonated water may be added after the raw material liquid is prepared in a concentrated state. A non-fermented beverage can be easily prepared by using a normal production process of a soft drink without a fermentation facility.

It is more desirable to remove the precipitate before the carbonation step or the carbonated water addition step because the causative substances of lees and off-flavor can be removed.

The beer-taste beverage thus produced according to the fourth aspect of the present invention is filled in a predetermined container and distributed to the market as a product.

The method of packaging the beer-taste beverage is not particularly limited, and a packaging method known to those skilled in the art can be used. Through the packaging step, the beer-taste beverage according to the present invention is filled and sealed in a container. In the packaging step, a container of any form and material may be used, and examples of the container include containers described in “1.4 Packaged beverage”.

### 3. Method for Improving Flavor of Beer-Taste Beverage

### 3.1 Method for Improving Flavor of Beer-Taste Beverage According to First Aspect of Present Invention

The present invention also relates to a method for improving a flavor of a beer-taste beverage. Specifically, in the method for improving a flavor according to the first aspect of the present invention, the beer-taste beverage is adjusted to have an original extract concentration greater than or equal to 20.0 mass %, an apparent attenuation greater than or equal to 70.0% or more, and an alcohol content less than or equal to 25.0 (v/v) %.

In the present specification, the “flavor” of the beer-taste beverage includes a delicious taste of barley, a rich taste derived from barley, drinking sensation, and a robust taste. In addition, in the present specification, “flavor improvement” or “improving flavor” means that, in a beverage in which the apparent attenuation and the original extract concentration are adjusted to the above-described ranges, enhancement of a beer-like taste of barley or a clear taste that is easy to drink is achieved as compared with a beverage in which the adjustment is not performed.

The method for adjusting the original extract concentration and the apparent attenuation is as described above in “1. Beer-Taste Beverage” and “2. Method for Producing Beer-Taste Beverage”.

### 3.2 Method for Improving Flavor of Beer-Taste Beverage According to Second Aspect of Present Invention

The present invention also relates to a method for improving a flavor of a beer-taste beverage. Specifically, in the method for improving a flavor according to the second aspect of the present invention, the beer-taste beverage is adjusted to have a real extract concentration less than or equal to 11.8 mass % and an alcohol content greater than or equal to 10.5 (v/v) %.

The method for adjusting the real extract concentration and the alcohol content is as described above in “1. Beer-Taste Beverage” and “2. Method for Producing Beer-Taste Beverage”.

### 3.3 Method for Improving Flavor of Beer-Taste Beverage According to Third Aspect of Present Invention

The present invention also relates to a method for improving a flavor of a beer-taste beverage. Specifically, in the method for improving a flavor according to the third aspect of the present invention, the beer-taste beverage is adjusted to have an apparent attenuation greater than or equal to 70.0% and an alcohol content greater than or equal to 10.5 (v/v) %.

The method for adjusting the apparent attenuation and the alcohol content is as described above in “1. Beer-Taste Beverage” and “2. Method for Producing Beer-Taste Beverage”.

### 3.4 Method for Improving Flavor of Beer-Taste Beverage According to Fourth Aspect of Present Invention

The present invention also relates to a method for improving a flavor of a beer-taste beverage. Specifically, in the method for improving a flavor according to the fourth aspect of the present invention, the beer-taste beverage is adjusted to have an original extract concentration greater than or equal to 19.2 mass % and an alcohol content greater than or equal to 12.5 (v/v) %.

The method for adjusting the original extract concentration and the alcohol content is as described above in “1. Beer-Taste Beverage” and “2. Method for Producing Beer-Taste Beverage”.

### EXAMPLES

Hereinafter, the present invention will be described in more detail by examples and the like, but the present invention is not limited by these examples.

In addition, in the examples, the original extract concentration and the apparent attenuation were measured by a method described in Revised BCOJ Beer Analysis Method (published by Public Interest Incorporated Foundation, The Brewing Society of Japan, edited by [Analysis Committee] Brewery Convention of Japan, Brewers Association of Japan, Enlarged and Revised Edition of 2013).

### 1 Examples of First Aspect of Present Invention

### Preparation of Beverage

Crushed barley malt was fed in a preparation tank containing 120 L of warm water, then the temperature was repeatedly raised and kept in a stepwise manner, and then malt dregs were removed by filtration. After filtration, the raw material liquid and hops were charged into a boiling kettle, a sugar solution was added thereto to have a specified malt proportion, and the mixture was adjusted to 100 L with warm water, resulting in the formation of hot wort. Note that the malt proportion was adjusted to 40 to 100%, and no sugar solution was added to a beer-taste beverage having a malt proportion of 100%.

The resulting hot wort was cooled and aerated with oxygen, resulting in the formation of 60 L of a pre-fermentation liquid to which yeast was still not added.

A brewer's yeast (top-fermenting yeast) was added to the pre-fermentation liquid thus produced, and the mixture was fermented for about one week. After a further aging period of about one week, the brewer's yeast was removed by filtration, and extract-adjusted water was added to prepare a beer-taste beverage.

In each of Examples and Comparative Examples, the amounts and types of raw materials such as malt and hops, mashing pattern, types of polysaccharide degrading enzyme and proteolytic enzyme, addition amounts and addition timings, set temperature in each temperature region during wort preparation, holding time, pH adjustment, turbidity during wort filtration, hop addition timing, boiling time, fermentation conditions, and the like were set as appropriate to achieve the chromaticity greater than or equal to 5 EBC, the alcohol content less than 25.0%, and the original extract concentration, the apparent attenuation, the pH, and the phosphoric acid content shown in Table 1.

### Sensory Evaluation

Evaluation of the resulting beer-taste beverages was performed as follows by taste-testing each beverage by the same six panelists.

Each of the panelists taste-tested the beer-taste beverage cooled to about 4° C., and evaluated evaluation items of “beer-like taste of barley” and “clear and easy-to-drink taste” with scores in increments of 0.1 in the range of 3.0 (maximum) to 1.0 (minimum) based on the following score criteria, and the average value of the scores of the six panelists was calculated.

In the evaluation, samples that meet the following criteria “1.0”, “2.0”, and “3.0” were prepared in advance to standardize the criteria among the panelists. In addition, in the sensory evaluation of all examples and comparative examples, for the same beverage, no difference in a score value of greater than or equal to 2.0 was observed among the panelists.

### Beer-Like Taste of Barley

“3.0”: The beer-like taste of barley is very strongly perceived.
“2.5”: The beer-like taste of barley is strongly perceived.
“2.0”: The beer-like taste of barley is perceived.
“1.5”: The beer-like taste of barley is poorly perceived.
“1.0”: The beer-like taste of barley is hardly perceived.

### Clear and Easy-to-Drink Taste

“3.0”: The clear and easy-to-drink taste is very strongly perceived.
“2.5”: The clear and easy-to-drink taste is strongly perceived.
“2.0”: The clear and easy-to-drink taste is perceived.
“1.5”: The clear and easy-to-drink taste is poorly perceived.
“1.0”: The clear and easy-to-drink taste is hardly perceived.

Based on the above three evaluation items, overall evaluation was made according to the following criteria.

### Overall Evaluation

“A”: All of the average scores of the two tested sensory evaluation items are greater than or equal to 2.0.
“B”: Either one of the average scores of the two tested sensory evaluation items is less than 2.0.

TABLE 1

| | | Example 1 | Example 2 | Example 3 | Example 4 | Example 5 | Example 6 | Example 7 | Example 8 |
|---|---|---|---|---|---|---|---|---|---|
| Original extract | w/w % | 30.0 | 30.0 | 30.0 | 28.0 | 28.0 | 27.5 | 27.5 | 26.0 |
| concentration | | | | | | | | | |
| Apparent attenuation | % | 90.0 | 70.0 | 110.0 | 102.0 | 95.0 | 90.0 | 70.0 | 105.0 |
| pH | | 4.3 | 4.5 | 3.5 | 4.0 | 4.2 | 4.3 | 4.5 | 4.0 |
| Phosphoric acid content | ppm | 1200 | 800 | 2000 | 1600 | 1500 | 1100 | 750 | 1500 |
| Beer-like taste of barley | | 2.9 | 3.0 | 2.8 | 2.6 | 2.7 | 2.8 | 2.8 | 2.4 |
| Clear and easy-to- | | 2.5 | 2.2 | 3.0 | 2.8 | 2.7 | 2.4 | 2.2 | 2.7 |
| drink taste | | | | | | | | | |
| Overall evaluation | | A | A | A | A | A | A | A | A |
| | | Example 9 | Example 10 | Example 11 | Example 12 | Example 13 | Example 14 | Example 15 | Example 16 |
| Original extract | w/w % | 25.0 | 25.0 | 23.0 | 22.5 | 22.5 | 20.0 | 20.0 | 20.0 |
| concentration | | | | | | | | | |
| Apparent attenuation | % | 90.0 | 70.0 | 104.0 | 90.0 | 70.0 | 110.0 | 100.0 | 90.0 |
| pH | | 4.3 | 4.5 | 4.0 | 4.3 | 4.5 | 3.5 | 4.0 | 4.3 |
| Phosphoric acid content | ppm | 1000 | 700 | 1300 | 900 | 650 | 1400 | 1300 | 800 |
| Beer-like taste of barley | | 2.5 | 2.6 | 2.2 | 2.3 | 2.4 | 2.0 | 2.1 | 2.2 |
| Clear and easy-to- | | 2.4 | 2.1 | 2.6 | 2.3 | 2.0 | 2.8 | 2.6 | 2.2 |
| drink taste | | | | | | | | | |
| Overall evaluation | | A | A | A | A | A | A | A | A |
| | | Example | Example | Comparative | Comparative | Comparative | Comparative | Comparative | Comparative |
| | | 17 | 18 | Example 1 | Example 2 | Example 3 | Example 4 | Example 5 | Example 6 |
| Original extract | w/w % | 20.0 | 20.0 | 30.0 | 25.0 | 20.0 | 18.0 | 18.0 | 18.0 |
| concentration | | | | | | | | | |
| Apparent attenuation | % | 80.0 | 70.0 | 60.0 | 60.0 | 60.0 | 70.0 | 90.0 | 100.0 |
| pH | | 4.4 | 4.5 | 5.0 | 4.8 | 4.7 | 4.8 | 4.8 | 4.8 |
| Phosphoric acid content | ppm | 700 | 550 | 1200 | 700 | 500 | 400 | 400 | 400 |
| Beer-like taste of barley | | 2.2 | 2.3 | 3.0 | 2.5 | 1.9 | 1.9 | 1.8 | 1.7 |
| Clear and easy-to- | | 2.1 | 2.0 | 1.3 | 1.5 | 1.9 | 2.0 | 2.0 | 2.0 |
| drink taste | | | | | | | | | |

| | | | | | | | | |
|---|---|---|---|---|---|---|---|---|
| Overall evaluation | A | A | B | B | B | B | B | B |

From the results of Examples, when in the beer-taste beverage, the original extract concentration was greater than or equal to 20.0 mass %, the apparent attenuation was greater than or equal to 70.0%, and the alcohol content was less than 25.0 (v/v) %, it was possible to provide a beverage having not only the “beer-like taste of barley” but also the “clear and easy-to-drink taste”.

### 2 Examples of Second Aspect of Present Invention

### Preparation of Beverage

Crushed barley malt was fed in a preparation tank containing 120 L of warm water, then the temperature was repeatedly raised and kept in a stepwise manner, and then malt dregs were removed by filtration. After filtration, the raw material liquid and hops were charged into a boiling kettle, a sugar solution was added thereto to have a malt proportion described in the table, and the mixture was adjusted to 100 L with warm water to obtain hot wort. Note that no sugar solution was added to a beer-taste beverage having a malt proportion of 100%.

The resulting hot wort was cooled and aerated with oxygen, resulting in the formation of 60 L of a pre-fermentation liquid to which yeast was still not added.

A brewer's yeast (top-fermenting yeast) was added to the pre-fermentation liquid thus produced, and the mixture was fermented for about one week. After a further aging period of about one week, the brewer's yeast was removed by filtration, and extract-adjusted water was added to prepare a beer-taste beverage.

In each of Examples and Comparative Examples, the amounts and types of raw materials such as malt and hops, mashing pattern, types of polysaccharide degrading enzyme, addition amount and addition timing, set temperature in each temperature region during wort preparation, holding time, pH adjustment, turbidity during wort filtration, hop addition timing, boiling time, fermentation conditions, and the like were set as appropriate to achieve the real extract concentration, the alcohol content, and the content of free amino nitrogen (FAN) shown in Tables 2 and 3.

### Sensory Evaluation

Evaluation of the resulting beer-taste beverages was performed as follows by taste-testing each beverage by the same six panelists.

Each of the panelists taste-tested the beer-taste beverage cooled to about 4° C., and evaluated evaluation items of “feeling of stimulation” and “clear and refreshing taste” with scores in increments of 0.1 in the range of 3.0 (maximum) to 1.0 (minimum) based on the following score criteria, and the average value of the scores of the six panelists was calculated.

In the evaluation, samples that meet the following criteria “1.0”, “2.0”, and “3.0” were prepared in advance to standardize the criteria among the panelists. In addition, in the sensory evaluation of all examples and comparative examples, for the same beverage, no difference in a score value of greater than or equal to 2.0 was observed among the panelists.

### Feeling of Stimulation

“3.0”: The feeling of stimulation is very strongly perceived.
“2.5”: The feeling of stimulation is strongly perceived.
“2.0”: The feeling of stimulation is perceived.
“1.5”: The feeling of stimulation is poorly perceived.
“1.0”: The feeling of stimulation is hardly perceived.

### Clear and Refreshing Taste

“3.0”: The clear and refreshing taste is very strongly perceived.
“2.5”: The clear and refreshing taste is strongly perceived.
“2.0”: The clear and refreshing taste is perceived.
“1.5”: The clear and refreshing taste is poorly perceived.
“1.0”: The clear and refreshing taste is hardly perceived.

Based on the above three evaluation items, overall evaluation was made according to the following criteria.

### Overall Evaluation

“S”: All of the average scores of the two tested sensory evaluation items are greater than or equal to 2.5.
“A”: All of the average scores of the two tested sensory evaluation items are greater than or equal to 2.0, which does not correspond to S.
“B”: Either one of the average scores of the two tested sensory evaluation items is less than 2.0.
“C”: All of the average scores of the two tested sensory evaluation items are less than 2.0.

TABLE 2

| | | Example | Example | Example | Example | Example | Example | Example | Example | Example | Example |
|---|---|---|---|---|---|---|---|---|---|---|---|
| | | 1 | 2 | 3 | 4 | 5 | 6 | 7 | 8 | 9 | 10 |
| Alcohol content | v/v % | 15.7 | 18.8 | 16.2 | 15.2 | 14.2 | 15.3 | 12.8 | 10.1 | 13.2 | 11.3 |
| Real extract | mass % | 8.4 | 3.6 | 5.1 | 6.7 | 7.7 | 4.1 | 6.9 | 10.9 | 3.8 | 6.2 |
| (R-Ex) | | | | | | | | | | | |
| Free Amino | mg/ | 25 | 25 | 22 | 22 | 22 | 20 | 18 | 18 | 16 | 16 |
| nitrogen | 100 mL | | | | | | | | | | |
| (FAN) | | | | | | | | | | | |
| Alcohol | — | 1.9 | 5.2 | 3.2 | 2.3 | 1.9 | 3.7 | 1.8 | 0.9 | 3.5 | 1.8 |
| content/R-Ex | | | | | | | | | | | |
| R-Ex/FAN | — | 0.34 | 0.15 | 0.23 | 0.30 | 0.35 | 0.21 | 0.39 | 0.61 | 0.24 | 0.39 |
| Malt proportion | % | 70 | 55 | 60 | 55 | 60 | 65 | 75 | 100 | 51 | 100 |
| Chromaticity | EBC | 40 | 50 | 30 | 40 | 30 | 40 | 40 | 10 | 5 | 10 |
| Feeling of stimulation | | 2.8 | 3.0 | 2.9 | 2.8 | 2.7 | 2.8 | 2.5 | 2.1 | 2.6 | 2.4 |
| Refreshing taste | | 2.3 | 3.0 | 2.8 | 2.5 | 2.3 | 2.8 | 2.3 | 2.0 | 2.7 | 2.3 |
| Overall evaluation | | A | S | S | S | A | S | A | A | S | A |
| | | Example | Example | Example | Example | Example | Example | Example | Example | Example | Example |
| | | 11 | 12 | 13 | 14 | 15 | 16 | 17 | 18 | 19 | 20 |
| Alcohol content | v/v % | 12.0 | 11.0 | 12.0 | 15.0 | 18.0 | 19.5 | 10.0 | 10.0 | 10.0 | 10.0 |
| Real extract | mass % | 2.3 | 3.9 | 11.0 | 11.0 | 11.0 | 11.0 | 8.0 | 6.0 | 4.0 | 2.0 |
| (R-Ex) | | | | | | | | | | | |
| Free Amino | mg/ | 15 | 15 | 25 | 25 | 30 | 32 | 17 | 17 | 17 | 17 |
| nitrogen | 100 mL | | | | | | | | | | |
| (FAN) | | | | | | | | | | | |
| Alcohol | — | 5.3 | 2.8 | 1.1 | 1.4 | 1.6 | 1.8 | 1.3 | 1.7 | 2.5 | 5.0 |
| content/R-Ex | | | | | | | | | | | |
| R-Ex/FAN | | 0.15 | 0.26 | 0.44 | 0.44 | 0.37 | 0.34 | 0.48 | 0.36 | 0.24 | 0.12 |
| Malt proportion | % | 100 | 75 | 100 | 70 | 60 | 51 | 100 | 100 | 100 | 100 |
| Chromaticity | EBC | 20 | 10 | 30 | 40 | 50 | 60 | 40 | 40 | 10 | 10 |
| Feeling of stimulation | | 2.4 | 2.1 | 2.2 | 2.5 | 2.8 | 3.0 | 2.0 | 2.0 | 2.0 | 2.0 |
| Refreshing taste | | 3.0 | 2.6 | 2.0 | 2.0 | 2.0 | 2.0 | 2.2 | 2.5 | 3.0 | 2.6 |
| Overall evaluation | | A | A | A | A | A | A | A | A | A | A |
| | | Example | Example | Example | Example | Example | Example | Example | Example | Example | Example |
| | | 21 | 22 | 23 | 24 | 25 | 26 | 27 | 28 | 29 | 30 |
| Alcohol content | v/v % | 15.0 | 17.0 | 18.0 | 19.5 | 16.0 | 17.0 | 18.0 | 19.5 | 15.0 | 16.0 |
| Real extract | mass % | 5.0 | 5.0 | 5.0 | 5.0 | 4.0 | 4.0 | 4.0 | 4.0 | 3.0 | 3.0 |
| (R-Ex) | | | | | | | | | | | |
| Free Amino | mg/ | 25 | 28 | 30 | 32 | 27 | 28 | 30 | 32 | 25 | 27 |
| nitrogen | 100 mL | | | | | | | | | | |
| (FAN) | | | | | | | | | | | |
| Alcohol | — | 3.0 | 3.4 | 3.6 | 3.9 | 4.0 | 4.3 | 4.5 | 4.9 | 5.0 | 5.3 |
| content/R-Ex | | | | | | | | | | | |
| R-Ex/FAN | | 0.20 | 0.18 | 0.17 | 0.15 | 0.15 | 0.14 | 0.13 | 0.12 | 0.12 | 0.11 |
| Malt proportion | % | 70 | 55 | 51 | 51 | 55 | 60 | 51 | 51 | 60 | 55 |
| Chromaticity | EBC | 20 | 30 | 30 | 40 | 50 | 40 | 40 | 40 | 30 | 30 |

| | | | | | | | | | | |
|---|---|---|---|---|---|---|---|---|---|---|
| Feeling of stimulation | 2.5 | 2.7 | 2.8 | 3.0 | 2.6 | 2.7 | 2.8 | 3.0 | 2.5 | 2.6 |
| Refreshing taste | 2.8 | 2.8 | 2.8 | 2.8 | 3.0 | 3.0 | 3.0 | 3.0 | 2.8 | 2.8 |
| Overall evaluation | S | S | S | S | S | S | S | S | S | S |

TABLE 3

| | | Example | Example | Example | Example | Example | Example | Example | Example | Example | | |
|---|---|---|---|---|---|---|---|---|---|---|---|---|
| | | 31 | 32 | 33 | 34 | 35 | 36 | 37 | 38 | 39 | | |
| Alcohol content | v/v % | 17.0 | 18.0 | 19.5 | 15.0 | 18.0 | 19.5 | 21.0 | 25.0 | 30.0 | | |
| Real extract | mass % | 3.0 | 3.0 | 3.0 | 2.0 | 2.0 | 2.0 | 4.0 | 3.3 | 2.8 | | |
| (R-Ex) | | | | | | | | | | | | |
| Free Amino | mg/ | 28 | 30 | 32 | 25 | 30 | 32 | 17 | 14 | 12 | | |
| nitrogen | 100 mL | | | | | | | | | | | |
| (FAN) | | | | | | | | | | | | |
| Alcohol content/ | — | 5.7 | 6.0 | 6.5 | 7.5 | 9.0 | 9.8 | 5.3 | 7.5 | 10.8 | | |
| R-Ex | | | | | | | | | | | | |
| R-Ex/FAN | | 0.11 | 0.10 | 0.09 | 0.08 | 0.07 | 0.06 | 0.23 | 0.23 | 0.23 | | |
| Malt proportion | % | 55 | 51 | 51 | 70 | 51 | 51 | 55 | 55 | 55 | | |
| Chromaticity | EBC | 40 | 30 | 70 | 40 | 50 | 80 | 40 | 40 | 40 | | |
| Feeling of stimulation | | 2.7 | 2.8 | 3.0 | 2.5 | 2.8 | 3.0 | 3.0 | 3.0 | 3.0 | | |
| Refreshing taste | | 2.8 | 2.8 | 2.8 | 2.6 | 2.6 | 2.6 | 2.8 | 2.8 | 2.9 | | |
| Overall evaluation | | S | S | S | S | S | S | S | S | S | | |
| | | Com- | Com- | Com- | Com- | Com- | Com- | Com- | Com- | Com- | Com- | Com- |
| | | parative | parative | parative | parative | parative | parative | parative | parative | parative | parative | parative |
| | | Example | Example | Example | Example | Example | Example | Example | Example | Example | Example | Example |
| | | 1 | 2 | 3 | 4 | 5 | 6 | 7 | 8 | 9 | 10 | 11 |
| Alcohol content | v/v % | 9.0 | 9.0 | 9.0 | 9.0 | 9.0 | 10.0 | 12.0 | 15.0 | 18.0 | 19.5 | 9.0 |
| Real extract | mass % | 11.0 | 8.0 | 6.0 | 4.0 | 2.0 | 12.0 | 12.0 | 12.0 | 12.0 | 12.0 | 12.0 |
| (R-Ex) | | | | | | | | | | | | |
| Free Amino | mg/ | 15 | 15 | 10 | 10 | 10 | 15 | 15 | 20 | 20 | 20 | 10 |
| nitrogen | 100 mL | | | | | | | | | | | |
| (FAN) | | | | | | | | | | | | |
| Alcohol content/ | — | 0.8 | 1.1 | 1.5 | 2.3 | 4.5 | 0.8 | 1.0 | 1.3 | 1.5 | 1.6 | 0.8 |
| R-Ex | | | | | | | | | | | | |
| R-Ex/FAN | | 0.73 | 0.53 | 0.60 | 0.40 | 0.20 | 0.80 | 0.80 | 0.60 | 0.60 | 0.60 | 1.20 |
| Malt proportion | % | 100 | 100 | 100 | 100 | 100 | 100 | 80 | 60 | 51 | 51 | 100 |
| Chromaticity | EBC | 10 | 10 | 10 | 10 | 10 | 20 | 20 | 20 | 20 | 20 | 20 |

| | | | | | | | | | | | |
|---|---|---|---|---|---|---|---|---|---|---|---|
| Feeling of stimulation | 1.8 | 1.8 | 1.8 | 1.8 | 1.8 | 2.0 | 2.2 | 2.5 | 2.8 | 3.0 | 1.8 |
| Refreshing taste | 2.0 | 2.2 | 2.5 | 2.8 | 3.0 | 1.8 | 1.8 | 1.8 | 1.8 | 1.8 | 1.8 |
| Overall evaluation | B | B | B | B | B | B | B | B | B | B | C |

From the results of Examples, when the real extract concentration in the beer-taste beverage was less than or equal to 11.8 mass % and the alcohol content was greater than or equal to 10.5 (v/v) %, it was possible to provide a beverage having a “clear and refreshing taste” while having a “feeling of stimulation”.

### 3 Embodiments of Third Aspect of Present Invention

### Preparation of Beverage

Crushed barley malt was fed in a preparation tank containing 120 L of warm water, then the temperature was repeatedly raised and kept in a stepwise manner, and then malt dregs were removed by filtration. After filtration, the raw material liquid and hops were charged into a boiling kettle, a sugar solution was added thereto to have a specified malt proportion, and the mixture was adjusted to 100 L with warm water, resulting in the formation of hot wort. Note that the malt proportion was adjusted to 40 to 100%, and no sugar solution was added to a beer-taste beverage having a malt proportion of 100%.

The resulting hot wort was cooled and aerated with oxygen, resulting in the formation of 60 L of a pre-fermentation liquid to which yeast was still not added.

In addition, in the beverages of Comparative Examples 8 to 10, the alcohol content was adjusted by adding spirits. In the beverages of the other Examples and Comparative Examples, neither ethanol nor ethanol composition was added.

A brewer's yeast (top-fermenting yeast) was added to the pre-fermentation liquid thus produced, and the mixture was fermented for about one week. After a further aging period of about one week, the brewer's yeast was removed by filtration, and extract-adjusted water was added to prepare a beer-taste beverage.

In each of Examples and Comparative Examples, the amounts and types of raw materials such as malt and hops, mashing pattern, types of polysaccharide degrading enzyme and proteolytic enzyme, addition amounts and addition timings, set temperature in each temperature region during wort preparation, holding time, pH adjustment, turbidity during wort filtration, hop addition timing, boiling time, fermentation conditions, and the like were set as appropriate to achieve the alcohol content, the apparent attenuation, and the total nitrogen amount shown in Table 4.

### Sensory Evaluation

Evaluation of the resulting beer-taste beverages was performed as follows by taste-testing each beverage by the same six panelists.

Each of the panelists taste-tested the beer-taste beverage cooled to about 4° C., and evaluated evaluation items of “feeling of stimulation derived from alcohol” and “clear and refreshing taste” with scores in increments of 0.1 in the range of 3.0 (maximum) to 1.0 (minimum) based on the following score criteria, and the average value of the scores of the six panelists was calculated.

In the evaluation, samples that meet the following criteria “1.0”, “2.0”, and “3.0” were prepared in advance to standardize the criteria among the panelists. In addition, in the sensory evaluation of all examples and comparative examples, for the same beverage, no difference in a score value of greater than or equal to 2.0 was observed among the panelists.

Feeling of Stimulation Derived from Alcohol
“3.0”: The feeling of stimulation derived from alcohol is very strongly perceived.
“2.5”: The feeling of stimulation derived from alcohol is strongly perceived.
“2.0”: The feeling of stimulation derived from alcohol is perceived.
“1.5”: The feeling of stimulation derived from alcohol is poorly perceived.
“1.0”: The feeling of stimulation derived from alcohol is hardly perceived.

### Clear and Refreshing Taste

“3.0”: The clear and refreshing taste is very strongly perceived.
“2.5”: The clear and refreshing taste is strongly perceived.
“2.0”: The clear and refreshing taste is perceived.
“1.5”: The clear and refreshing taste is poorly perceived.
“1.0”: The clear and refreshing taste is hardly perceived.

Based on the above three evaluation items, overall evaluation was made according to the following criteria.

### Overall Evaluation

“A”: All of the average scores of the two tested sensory evaluation items are greater than or equal to 2.0.
“B”: Either one of the average scores of the two tested sensory evaluation items is greater than or equal to 2.0.
“C”: All of the average scores of the two tested sensory evaluation items are less than 2.0.

TABLE 4

| | | Example | Example | Example | Example | Example | Example | Example | Example |
|---|---|---|---|---|---|---|---|---|---|
| | | 1 | 2 | 3 | 4 | 5 | 6 | 7 | 8 |
| Alcohol content | (v/v) % | 10.5 | 12.5 | 15.0 | 16.5 | 17.5 | 19.5 | 10.5 | 12.5 |
| Apparent attenuation | % | 70 | 70 | 70 | 70 | 70 | 70 | 80 | 80 |
| Apparent attenuation × | | 735 | 875 | 1050 | 1155 | 1225 | 1365 | 840 | 1000 |
| alcohol content | | | | | | | | | |
| Total nitrogen amount | mg/ | 79 | 98 | 118 | 130 | 138 | 154 | 79 | 98 |
| | 100 mL | | | | | | | | |
| Feeling of stimulation derived | | 2.0 | 2.2 | 2.4 | 2.6 | 2.8 | 3.0 | 2.0 | 2.2 |
| from alcohol | | | | | | | | | |
| Clear and refreshing taste | | 2.0 | 2.0 | 2.0 | 2.0 | 2.0 | 2.0 | 2.2 | 2.2 |
| Overall evaluation | | A | A | A | A | A | A | A | A |
| | | | | | | Example | Example | Example | Example |
| | | | | | | 9 | 10 | 11 | 12 |
| | | | Alcohol content | | (v/v) % | 15.0 | 16.5 | 17.5 | 19.5 |
| | | | Apparent attenuation | | % | 80 | 80 | 80 | 80 |
| | | | Apparent attenuation × | | | 1200 | 1320 | 1400 | 1560 |
| | | | alcohol content | | | | | | |
| | | | Total nitrogen amount | | mg/ | 118 | 130 | 138 | 154 |
| | | | | | 100 mL | | | | |
| | | | Feeling of stimulation derived | | | 2.4 | 2.6 | 2.8 | 3.0 |
| | | | from alcohol | | | | | | |
| | | | Clear and refreshing taste | | | 2.2 | 2.2 | 2.2 | 2.2 |
| | | | Overall evaluation | | | A | A | A | A |
| | | Example | Example | Example | Example | Example | Example | Example | Example |
| | | 13 | 14 | 15 | 16 | 17 | 18 | 19 | 20 |
| Alcohol content | (v/v) % | 10.5 | 12.5 | 15.0 | 16.5 | 17.5 | 19.5 | 10.5 | 12.5 |
| Apparent attenuation | % | 90 | 90 | 90 | 90 | 90 | 90 | 95 | 95 |
| Apparent attenuation × | | 945 | 1125 | 1350 | 1485 | 1575 | 1755 | 998 | 1188 |
| alcohol content | | | | | | | | | |
| Total nitrogen amount | mg/ | 79 | 98 | 118 | 130 | 138 | 154 | 79 | 98 |
| | 100 mL | | | | | | | | |
| Feeling of stimulation derived | | 2.0 | 2.2 | 2.4 | 2.6 | 2.8 | 3.0 | 2.0 | 2.2 |
| from alcohol | | | | | | | | | |
| Clear and refreshing taste | | 2.4 | 2.4 | 2.4 | 2.4 | 2.4 | 2.4 | 2.5 | 2.5 |
| Overall evaluation | | A | A | A | A | A | A | A | A |
| | | | | Example | Example | Example | Example | Example | Example |
| | | | | 21 | 22 | 23 | 24 | 25 | 26 |
| | Alcohol content | | (v/v) % | 15.0 | 16.0 | 16.5 | 17.0 | 17.5 | 19.5 |
| | Apparent attenuation | | % | 95 | 95 | 95 | 95 | 95 | 95 |
| | Apparent attenuation × | | | 1425 | 1520 | 1567 | 1615 | 1662 | 1852 |
| | alcohol content | | | | | | | | |
| | Total nitrogen amount | | mg/ | 118 | 126 | 130 | 134 | 138 | 154 |
| | | | 100 mL | | | | | | |
| | Feeling of stimulation derived | | | 2.4 | 2.5 | 2.6 | 2.7 | 2.8 | 3.0 |
| | from alcohol | | | | | | | | |
| | Clear and refreshing taste | | | 2.5 | 2.5 | 2.5 | 2.5 | 2.5 | 2.5 |
| | Overall evaluation | | | A | A | A | A | A | A |
| | | Example | Example | Example | Example | Example | Example | Example | Example |
| | | 27 | 28 | 29 | 30 | 31 | 32 | 33 | 34 |
| Alcohol content | (v/v) % | 10.5 | 12.5 | 15.0 | 16.0 | 16.5 | 17.0 | 17.5 | 19.5 |
| Apparent attenuation | % | 100 | 100 | 100 | 100 | 100 | 100 | 100 | 100 |
| Apparent attenuation × | | 1050 | 1250 | 1500 | 1600 | 1650 | 1700 | 1750 | 1950 |
| alcohol content | | | | | | | | | |
| Total nitrogen amount | mg/ | 79 | 98 | 118 | 126 | 130 | 134 | 138 | 154 |
| | 100 mL | | | | | | | | |
| Feeling of stimulation derived | | 2.0 | 2.2 | 2.4 | 2.5 | 2.6 | 2.7 | 2.8 | 3.0 |
| from alcohol | | | | | | | | | |
| Clear and refreshing taste | | 2.7 | 2.7 | 2.7 | 2.7 | 2.7 | 2.7 | 2.7 | 2.7 |
| Overall evaluation | | A | A | A | A | A | A | A | A |
| | | Example | Example | Example | Example | Example | Example | Example | Example |
| | | 35 | 36 | 37 | 38 | 39 | 40 | 41 | 42 |
| Alcohol content | (v/v) % | 10.5 | 12.5 | 15.0 | 16.0 | 16.5 | 17.0 | 17.5 | 19.5 |
| Apparent attenuation | % | 105 | 105 | 105 | 105 | 105 | 105 | 105 | 105 |
| Apparent attenuation × | | 1103 | 1313 | 1575 | 1680 | 1733 | 1785 | 1838 | 2047 |
| alcohol content | | | | | | | | | |
| Total nitrogen amount | mg/ | 79 | 98 | 118 | 126 | 130 | 134 | 138 | 154 |
| | 100 mL | | | | | | | | |
| Feeling of stimulation derived | | 2.0 | 2.2 | 2.4 | 2.5 | 2.6 | 2.7 | 2.8 | 3.0 |
| from alcohol | | | | | | | | | |
| Clear and refreshing taste | | 2.8 | 2.8 | 2.8 | 2.8 | 2.8 | 2.8 | 2.8 | 2.8 |
| Overall evaluation | | A | A | A | A | A | A | A | A |
| | | Example | Example | Example | Example | Example | Example | Example | Example |
| | | 43 | 44 | 45 | 46 | 47 | 48 | 49 | 50 |
| Alcohol content | (v/v) % | 10.5 | 12.5 | 15.0 | 16.0 | 16.5 | 17.0 | 17.5 | 19.5 |
| Apparent attenuation | % | 110 | 110 | 110 | 110 | 110 | 110 | 110 | 110 |
| Apparent attenuation × | | 1155 | 1375 | 1650 | 1760 | 1815 | 1870 | 1925 | 2145 |
| alcohol content | | | | | | | | | |
| Total nitrogen amount | mg/ | 79 | 98 | 118 | 126 | 130 | 134 | 138 | 154 |
| | 100 mL | | | | | | | | |
| Feeling of stimulation derived | | 2.0 | 2.2 | 2.4 | 2.5 | 2.6 | 2.7 | 2.8 | 3.0 |
| from alcohol | | | | | | | | | |
| Clear and refreshing taste | | 2.9 | 2.9 | 2.9 | 2.9 | 2.9 | 2.9 | 2.9 | 2.9 |
| Overall evaluation | | A | A | A | A | A | A | A | A |
| | | Com- | Com- | Com- | Com- | Com- | Com- | Com- | Com- |
| | | parative | parative | parative | parative | parative | parative | parative | parative |
| | | Example | Example | Example | Example | Example | Example | Example | Example |
| | | 1 | 2 | 3 | 4 | 5 | 6 | 7 | 8 |
| Alcohol content | (v/v)% | 9.00 | 9.00 | 9.00 | 9.00 | 9.00 | 9.00 | 12.50 | 15.00 |
| Apparent attenuation | % | 70 | 80 | 90 | 95 | 100 | 105 | 65 | 65 |
| Apparent attenuation × | | 630 | 720 | 810 | 855 | 900 | 945 | 813 | 975 |
| alcohol content | | | | | | | | | |
| Total nitrogen amount | mg/ | 60 | 60 | 50 | 50 | 50 | 60 | 60 | 65 |
| | 100 mL | | | | | | | | |

| Feeling of stimulation derived | 1.8 | 1.8 | 1.8 | 1.8 | 1.8 | 1.8 | 2.2 | 2.4 |
|---|---|---|---|---|---|---|---|---|
| from alcohol | | | | | | | | |
| Clear and refreshing taste | 2.0 | 2.2 | 2.4 | 2.5 | 2.7 | 2.9 | 1.8 | 1.8 |
| Overall evaluation | B | B | B | B | B | B | B | B |
| | | | | | | Com- | Com- | Com- |
| | | | | | | parative | parative | parative |
| | | | | | | Example | Example | Example |
| | | | | | | 9 | 10 | 11 |

| | | | | |
|---|---|---|---|---|
| Alcohol content | (v/v)% | 17.50 | 19.50 | 9.00 |
| Apparent attenuation | % | 65 | 65 | 65 |
| Apparent attenuation × | | 1138 | 1268 | 585 |
| alcohol content | | | | |
| Total nitrogen amount | mg/ | 65 | 65 | 40 |
| | 100 mL | | | |

| | | | |
|---|---|---|---|
| Feeling of stimulation derived | 2.8 | 3.0 | 1.8 |
| from alcohol | | | |
| Clear and refreshing taste | 1.8 | 1.8 | 1.8 |
| Overall evaluation | B | B | C |

From the results of Examples, when the apparent attenuation in the beer-taste beverage was greater than or equal to 70.0% and the alcohol content was greater than or equal to 10.5 (v/v) %, it was possible to provide a beverage having a “clear and refreshing taste” while having a “feeling of stimulation derived from alcohol”.

### 4 Examples of Fourth Aspect of Present Invention

### Preparation of Beverage

Crushed barley malt was fed in a preparation tank containing 120 L of warm water, then the temperature was repeatedly raised and kept in a stepwise manner, and then malt dregs were removed by filtration. After filtration, the raw material liquid and hops were charged into a boiling kettle, a sugar solution was added thereto to have a specified malt proportion, and the mixture was adjusted to 100 L with warm water, resulting in the formation of hot wort. Note that the malt proportion was adjusted to 40 to 100%, and no sugar solution was added to a beer-taste beverage having a malt proportion of 100%.

The resulting hot wort was cooled and aerated with oxygen, resulting in the formation of 60 L of a pre-fermentation liquid to which yeast was still not added.

In addition, in the beverages of Comparative Examples 7 to 10, the alcohol content was adjusted by adding spirits. In the beverages of the other Examples and Comparative Examples, neither ethanol nor ethanol composition was added.

A brewer's yeast (top-fermenting yeast) was added to the pre-fermentation liquid thus produced, and the mixture was fermented for about one week. After a further aging period of about one week, the brewer's yeast was removed by filtration, and extract-adjusted water was added to prepare a beer-taste beverage.

In each of Examples and Comparative Examples, the amounts and types of raw materials such as malt and hops, mashing pattern, types of polysaccharide degrading enzyme and proteolytic enzyme, addition amounts and addition timings, set temperature in each temperature region during wort preparation, holding time, pH adjustment, turbidity during wort filtration, hop addition timing, boiling time, fermentation conditions, and the like were set as appropriate to achieve the alcohol content, original extract concentration, and total polyphenol amount shown in Table 5.

### Sensory Evaluation

Evaluation of the resulting beer-taste beverages was performed as follows by taste-testing each beverage by the same six panelists.

Each of the panelists taste-tested the beer-taste beverage cooled to about 4° C., and evaluated evaluation items of “feeling of stimulation derived from alcohol” and “taste of barley” with scores in increments of 0.1 in the range of 3.0 (maximum) to 1.0 (minimum) based on the following score criteria, and the average value of the scores of the six panelists was calculated.

In the evaluation, samples that meet the following criteria “1.0”, “2.0”, and “3.0” were prepared in advance to standardize the criteria among the panelists. In addition, in the sensory evaluation of all examples and comparative examples, for the same beverage, no difference in a score value of greater than or equal to 2.0 or more was observed among the panelists.

Feeling of Stimulation Derived from Alcohol
“3.0”: The feeling of stimulation derived from alcohol is very strongly perceived.
“2.5”: The feeling of stimulation derived from alcohol is strongly perceived.
“2.0”: The feeling of stimulation derived from alcohol is perceived.
“1.5”: The feeling of stimulation derived from alcohol is poorly perceived.
“1.0”: The feeling of stimulation derived from alcohol is hardly perceived.

### Taste of Barley

“3.0”: The taste of barley is very strongly perceived.
“2.5”: The taste of barley is strongly perceived.
“2.0”: The taste of barley is perceived.
“1.5”: The taste of barley is poorly perceived.
“1.0”: The taste of barley is hardly perceived.

Based on the above three evaluation items, overall evaluation was made according to the following criteria.

### Overall Evaluation

“A”: All of the average scores of the two tested sensory evaluation items are greater than or equal to 2.0.
“B”: Either one of the average scores of the two tested sensory evaluation items is greater than or equal to 2.0.
“C”: All of the average scores of the two tested sensory evaluation items are less than 2.0.

TABLE 5

| | | Example | Example | Example | Example | Example | Example | Example | Example |
|---|---|---|---|---|---|---|---|---|---|
| | | 1 | 2 | 3 | 4 | 5 | 6 | 7 | 8 |
| Alcohol content | (v/v) % | 12.5 | 12.5 | 12.5 | 12.5 | 12.5 | 12.5 | 15.0 | 15.0 |
| Original extract | (w/w) % | 20.0 | 22.5 | 25.0 | 27.5 | 30.0 | 32.0 | 20.0 | 22.5 |
| concentration | | | | | | | | | |
| Original extract | | 250 | 281 | 313 | 344 | 375 | 400 | 300 | 338 |
| concentration × | | | | | | | | | |
| alcohol content | | | | | | | | | |
| Total polyphenol | mg/L | 100 | 100 | 100 | 100 | 100 | 100 | 150 | 150 |
| amount | | | | | | | | | |
| Feeling of stimulation | | 2.2 | 2.2 | 2.2 | 2.2 | 2.2 | 2.2 | 2.4 | 2.4 |
| derived from alcohol | | | | | | | | | |
| Taste of barley | | 2.0 | 2.2 | 2.4 | 2.5 | 2.9 | 3.0 | 2.0 | 2.2 |
| Overall evaluation | | A | A | A | A | A | A | A | A |
| | | | | | | Example | Example | Example | Example |
| | | | | | | 9 | 10 | 11 | 12 |
| | | | Alcohol content | | (v/v) % | 15.0 | 15.0 | 15.0 | 15.0 |
| | | | Original extract | | (w/w) % | 25.0 | 27.5 | 30.0 | 32.0 |
| | | | concentration | | | | | | |
| | | | Original extract | | | 375 | 413 | 450 | 480 |
| | | | concentration × | | | | | | |
| | | | alcohol content | | | | | | |
| | | | Total polyphenol | | mg/L | 150 | 150 | 150 | 150 |
| | | | amount | | | | | | |
| | | | Feeling of stimulation | | | 2.4 | 2.4 | 2.4 | 2.4 |
| | | | derived from alcohol | | | | | | |
| | | | Taste of barley | | | 2.4 | 2.5 | 2.9 | 3.0 |
| | | | Overall evaluation | | | A | A | A | A |
| | | Example | Example | Example | Example | Example | Example | Example | Example |
| | | 13 | 14 | 15 | 16 | 17 | 18 | 19 | 20 |
| Alcohol content | (v/v) % | 16.0 | 16.0 | 16.0 | 16.0 | 16.0 | 16.0 | 16.0 | 16.0 |
| Original extract | (w/w) % | 20.0 | 22.5 | 25.0 | 27.5 | 28.0 | 28.5 | 30.0 | 32.0 |
| concentration | | | | | | | | | |
| Original extract | | 320 | 360 | 400 | 440 | 448 | 456 | 480 | 512 |
| concentration × | | | | | | | | | |
| alcohol content | | | | | | | | | |
| Total polyphenol | mg/L | 220 | 220 | 220 | 220 | 220 | 220 | 220 | 220 |
| amount | | | | | | | | | |
| Feeling of stimulation | | 2.5 | 2.5 | 2.5 | 2.5 | 2.5 | 2.5 | 2.5 | 2.5 |
| derived from alcohol | | | | | | | | | |
| Taste of barley | | 2.0 | 2.2 | 2.4 | 2.5 | 2.6 | 2.7 | 2.9 | 3 |
| Overall evaluation | | A | A | A | A | A | A | A | A |
| | | Example | Example | Example | Example | Example | Example | Example | Example |
| | | 21 | 22 | 23 | 24 | 25 | 26 | 27 | 28 |
| Alcohol content | (v/v) % | 16.5 | 16.5 | 16.5 | 16.5 | 16.5 | 16.5 | 16.5 | 16.5 |
| Original extract | (w/w) % | 20.0 | 22.5 | 25.0 | 27.5 | 28.0 | 28.5 | 30.0 | 32.0 |
| concentration | | | | | | | | | |
| Original extract | | 330 | 371 | 413 | 454 | 462 | 470 | 495 | 528 |
| concentration × | | | | | | | | | |
| alcohol content | | | | | | | | | |
| Total polyphenol | mg/L | 290 | 290 | 290 | 290 | 290 | 290 | 290 | 290 |
| amount | | | | | | | | | |
| Feeling of stimulation | | 2.6 | 2.6 | 2.6 | 2.6 | 2.6 | 2.6 | 2.6 | 2.6 |
| derived from alcohol | | | | | | | | | |
| Taste of barley | | 2.0 | 2.2 | 2.4 | 2.5 | 2.6 | 2.7 | 2.9 | 3 |
| Overall evaluation | | A | A | A | A | A | A | A | A |
| | | Example | Example | Example | Example | Example | Example | Example | Example |
| | | 29 | 30 | 31 | 32 | 33 | 34 | 35 | 36 |
| Alcohol content | (v/v) % | 17.0 | 17.0 | 17.0 | 17.0 | 17.0 | 17.0 | 17.0 | 17.0 |
| Original extract | (w/w) % | 20.0 | 22.5 | 25.0 | 27.5 | 28.0 | 28.5 | 30.0 | 32.0 |
| concentration | | | | | | | | | |
| Original extract | | 340 | 383 | 425 | 468 | 476 | 485 | 510 | 544 |
| concentration × | | | | | | | | | |
| alcohol content | | | | | | | | | |
| Total polyphenol | mg/L | 320 | 320 | 320 | 320 | 320 | 320 | 320 | 320 |
| amount | | | | | | | | | |
| Feeling of stimulation | | 2.7 | 2.7 | 2.7 | 2.7 | 2.7 | 2.7 | 2.7 | 2.7 |
| derived from alcohol | | | | | | | | | |
| Taste of barley | | 2.0 | 2.2 | 2.4 | 2.5 | 2.6 | 2.7 | 2.9 | 3 |
| Overall evaluation | | A | A | A | A | A | A | A | A |
| | | Example | Example | Example | Example | Example | Example | | |
| | | 37 | 38 | 39 | 40 | 41 | 42 | | |
| Alcohol content | (v/v) % | 19.5 | 19.5 | 19.5 | 19.5 | 19.5 | 19.5 | | |
| Original extract | (w/w) % | 20.0 | 22.5 | 25.0 | 27.5 | 30.0 | 32.0 | | |
| concentration | | | | | | | | | |
| Original extract | | 390 | 439 | 488 | 536 | 585 | 624 | | |
| concentration × | | | | | | | | | |
| alcohol content | | | | | | | | | |
| Total polyphenol | mg/L | 350 | 350 | 350 | 350 | 350 | 350 | | |
| amount | | | | | | | | | |
| Feeling of stimulation | | 3.0 | 3.0 | 3.0 | 3.0 | 3.0 | 3.0 | | |
| derived from alcohol | | | | | | | | | |
| Taste of barley | | 2.0 | 2.2 | 2.4 | 2.7 | 2.9 | 3.0 | | |
| Overall evaluation | | A | A | A | A | A | A | | |
| | | Com- | Com- | Com- | Com- | Com- | Com- | Com- | Com- |
| | | parative | parative | parative | parative | parative | parative | parative | parative |
| | | Example | Example | Example | Example | Example | Example | Example | Example |
| | | 1 | 2 | 3 | 4 | 5 | 6 | 7 | 8 |
| Alcohol content | (v/v) % | 9.0 | 9.0 | 9.0 | 9.0 | 10.0 | 12.5 | 15.0 | 16.0 |
| Original extract | (w/w) % | 20.0 | 25.0 | 30.0 | 32.0 | 19.0 | 19.0 | 19.0 | 19.0 |
| concentration | | | | | | | | | |
| Original extract | | 180 | 225 | 270 | 288 | 190 | 238 | 285 | 304 |
| concentration × | | | | | | | | | |
| alcohol content | | | | | | | | | |
| Total polyphenol | mg/L | 40 | 100 | 150 | 170 | 40 | 40 | 40 | 40 |
| amount | | | | | | | | | |

| Feeling of stimulation | 1.8 | 1.8 | 1.8 | 1.8 | 2.0 | 2.2 | 2.4 | 2.5 |
|---|---|---|---|---|---|---|---|---|
| derived from alcohol | | | | | | | | |
| Taste of barley | 2.0 | 2.4 | 2.9 | 3.0 | 1.8 | 1.8 | 1.8 | 1.8 |
| Overall evaluation | B | B | B | B | B | B | B | B |
| | | | | | | Com- | Com- | Com- |
| | | | | | | parative | parative | parative |
| | | | | | | Example | Example | Example |
| | | | | | | 9 | 10 | 11 |

| | | | | |
|---|---|---|---|---|
| Alcohol content | (v/v) % | 17.0 | 19.5 | 9.0 |
| Original extract | (w/w) % | 19.0 | 19.0 | 19.0 |
| concentration | | | | |
| Original extract | | 323 | 371 | 171 |
| concentration × | | | | |
| alcohol content | | | | |
| Total polyphenol | mg/L | 40 | 40 | 40 |
| amount | | | | |

| | | | |
|---|---|---|---|
| Feeling of stimulation | 2.7 | 3.0 | 1.8 |
| derived from alcohol | | | |
| Taste of barley | 1.8 | 1.8 | 1.8 |
| Overall evaluation | B | B | C |

From the results of Examples, when in the beer-taste beverage, the original extract concentration was greater than or equal to 19.2 mass %, the alcohol content was greater than or equal to 12.5 (v/v) %, the total polyphenol amount was greater than or equal to 42 mg/L, and the malt proportion was greater than or equal to 40 mass %, it was possible to provide a beverage having the “taste of barley” while having the “feeling of stimulation derived from alcohol”.

1. A beer-taste beverage having an original extract concentration greater than or equal to 20.0 mass %, an apparent attenuation greater than or equal to 70.0%, and an alcohol content less than 25.0 (v/v) %.

2-6. (canceled)

7. A method for producing a beer-taste beverage having an original extract concentration greater than or equal to 20.0 mass % and an alcohol content less than 25.0 (v/v) %, the method comprising performing fermentation in such a manner that an apparent attenuation of the beer-taste beverage is greater than or equal to 70.0%.

8. (canceled)

9. A beer-taste beverage having a real extract concentration less than or equal to 11.8 mass % and an alcohol content greater than or equal to 10.5 (v/v) %.

10-16. (canceled)

17. A method for producing a beer-taste beverage having a real extract concentration less than or equal to 11.8 mass %, the method comprising performing fermentation in such a manner that an alcohol content of the beer-taste beverage is greater than or equal to 10.5 (v/v) %.

18. (canceled)

19. A beer-taste beverage having an apparent attenuation greater than or equal to 70.0% and an alcohol content greater than or equal to 10.5 (v/v) %.

20-26. (canceled)

27. A method for producing a beer-taste beverage, the method comprising performing fermentation in such a manner that an apparent attenuation is greater than or equal to 70.0% and an alcohol content is greater than or equal to 10.5 (v/v) %.

28-29. (canceled)

30. A beer-taste beverage having an original extract concentration greater than or equal to 19.2 mass % and an alcohol content greater than or equal to 12.5 (v/v) %.

31-37. (canceled)

38. A method for producing a beer-taste beverage having an original extract concentration greater than or equal to 19.2 mass %, the method comprising performing fermentation in such a manner that an alcohol content is greater than or equal to 12.5 (v/v) %.

39-40. (canceled)
